(19) United States
(12) Patent Application Publication
(10) Pub. No.: US 2015/0052102 A1
(43) Pub. Date: Feb. 19, 2015

(54) SYSTEMS AND METHODS FOR CREATING A TEMPORAL CONTENT PROFILE

(71) Applicant: Perwaiz Nihal, (US)

(72) Inventor: Perwaiz Nihal, Dublin, NH (US)

(21) Appl. No.: 14/376,651

(22) PCT Filed: Mar. 8, 2013
(86) PCT No.: PCT/US13/29922

§ 371 Date: Aug. 5, 2014

Related U.S. Application Data
(60) Provisional application No. 61/608,132, filed on Mar. 8, 2012.

(51) Int. Cl. G06F 17/30

(52) U.S. Cl. CPC G06F 17/30575; G06F 17/30876
USPC 707/610

(57) ABSTRACT

A method of creating a temporal content profile comprising the steps of receiving a content instance, receiving a metadata associated with the content instance, creating a content instance profile and creating a temporal content profile from the first content instance profile. In some embodiments, the temporal content profile comprises a first and a second content instance profile, each having a content instance and metadata. In some embodiments, the computer implemented methods comprise outputting a representation of a temporal content profile comprising the steps of receiving a representation of a content instance profile comprising a content instance and a metadata and outputting the representation of the temporal content profile to a user interface.

### CROSS-REFERENCE TO RELATED APPLICATIONS

This application claims the benefit of U.S. App. No. 61/608,132, filed on Mar. 8, 2012, entitled “SYSTEMS AND METHODS FOR CREATING A TEMPORAL CONTENT PROFILE,” the entire contents of which is incorporated herein by reference.

### BACKGROUND

1. Field of the Invention

Television programs succeed or fail based on audience reaction. A measure of the audience's reaction to a television program is meaningful to television stations that produce such programs. Since the 1950's audience rating companies have provided audience measurement information for television programs, including ratings/share, and audience demographics, as well as ratings for the commercials that are shown during television programs.

2. Background of the Invention

Conventional technologies for matching television ratings data to their respective television programs suffer from a variety of deficiencies. In particular, conventional technologies for matching television ratings data to their respective television programs are limited in that conventional technologies typically require manually mapping various inputs (i.e., television programs from local markets, national markets, etc.), that are formatted and delivered differently, to the associated ratings, which can also can be provided in different formats (i.e., ratings based on time slot, ratings based on similar television programs regardless of time slots, etc.) in order to produce useful assimilation of the data. As the number of television markets (with network, cable and satellite stations), the variety of television programs, commercials, and methods of viewing (for example, on-demand viewing, recording for later viewing, etc.) have increased, this daunting task has become difficult to perform manually on a comprehensive scale within a time frame where the data is still relevant.

### BRIEF SUMMARY

The following summary is included only to introduce some concepts discussed in the Detailed Description below. This summary is not comprehensive and is not intended to delineate the scope of protectable subject matter, which is set forth by the Detailed Description and the claims presented at the end.

In one example embodiment, a computer implemented method of creating a temporal content profile is provided comprising receiving a content instance, receiving a metadata associated with the content instance, creating a content instance profile and creating a temporal content profile from the content instance profile.

Some example embodiments disclosed herein provide systems and methods to create a temporal content profile. In an example embodiment, temporal content is media that has different content, or different content instances, over a temporal dimension such as time. The first content instance may represent content at a first point in time, and the second content instance may represent content at a second point in time. The temporal content profile creating process receives a first metadata associated with the first content instance and a second metadata associated with the second content instance. In some embodiments, the temporal content profile creating process also receives metadata that may be any type of data associated with the content. The temporal content profile creating process creates a first content instance profile by synchronizing the first content instance with the first metadata. The temporal content profile creating process also creates a second content instance profile by synchronizing the second content instance with the second metadata. In some embodiments, the content instance profile comprises the metadata and the content associated with that instance. Each point (i.e., content instance) in media, for example, a video, or television program, may have metadata associated with that particular point in the media. For example, each point in a video may have ratings data, closed caption text, video name, the time the video aired, the television station airing the video, etc. The temporal content profile creating process creates a first temporal content profile from the first content instance profile and another, or second, content instance profile. The temporal content profile may reflect a series of content instance profiles such as over a period of time.

One example embodiment, a computer implemented method of outputting a representation of a temporal content profile is provided comprising receiving a representation of a content instance profile, the content instance profile comprising a content instance and a metadata, associating the content instance profile with the metadata, such as a temporal value, to create a temporal content profile and outputting a representation of the temporal content profile.

In one example embodiment, a computer implemented method to compare temporal content is provided comprising receiving a first and second temporal content each having metadata, synchronizing the temporal content and metadata on a selected metadata field or metadata field value and comparing a the value of the compared metadata field value of the first temporal content to the value of the compared metadata field of the second temporal content. The comparison may be between temporal content, metadata associated with the temporal content or between temporal content profiles.

In one example embodiment, a computer implemented method of a determining a comparison of temporal content is provided comprising receiving a first temporal content and a second temporal content, the first temporal content associated with a first metadata and the second temporal content associated with a second metadata, the first metadata and the second metadata comprising at least one metadata field having at least one metadata field value, selecting at least one metadata field as a selected metadata field, synchronizing the first metadata and the second metadata on a selected metadata field value of the selected metadata field, selecting at least one metadata field as a compared metadata field and comparing the metadata field value of the compared metadata field of the first metadata to the metadata field value of the compared metadata field of the second metadata to compare the first temporal content to the second temporal content. To illustrate and example of this embodiment, and not for limitation, temporal content may be multiple video files with metadata fields comprising time-in-program, program type and ratings. With the metadata fields populated with metadata field values, the video files can be synchronized on both a time-in-program value and a program type value, such as evening news, and the ratings value, such as an audience measure, can be compared to see how the ratings values compare for similar programs at a similar time-in-program values.

Example embodiments disclosed herein may include any type of computer implemented or computerized device, workstation, handheld or laptop computer, or the like configured with software and/or circuitry (e.g., a processor) to process any or all of the method operations disclosed herein. In other words, a computerized device such as a computer or a data communications device or any type of processor based device that is programmed or configured to operate as explained herein is considered an embodiment disclosed herein.

Example embodiments of systems disclosed herein may include software programs to perform the steps and operations summarized above and disclosed in detail below. One example embodiment comprises a computer program product that has a computer-readable medium including computer program logic encoded thereon that, when performed in a computerized device having a coupling of a memory and a processor, programs the processor to perform the operations or processes disclosed herein.

It is to be understood that the system disclosed herein may be embodied strictly as a software program, as software and hardware, or as hardware alone. The embodiments disclosed herein, may be employed in data communications devices and other computerized devices and software systems for such devices.

### BRIEF DESCRIPTION OF THE SEVERAL VIEWS OF THE DRAWINGS

In order that the manner in which the above-recited and other advantages and features of embodiments disclosed herein are obtained, a more particular description of embodiments disclosed herein briefly described above will be rendered by reference to specific embodiments thereof which are illustrated in the appended drawings. Understanding that these drawings depict only typical embodiments of embodiments disclosed herein and are not therefore to be considered to be limiting of its scope, embodiments disclosed herein will be described and explained with additional specificity and detail through the use of the accompanying drawings in which:

FIG. 1 shows a high-level block diagram of an example of a first temporal content profile according to one example embodiment disclosed herein;

FIG. 2 shows a high-level block diagram of an example system for creating a temporal content profile according to one example embodiment disclosed herein;

FIG. 3 is a schematic diagram of one embodiment of a generic computer system;

FIG. 4 shows a high-level flowchart of one example process of creating the temporal content profile;

FIG. 5 shows a high-level flowchart of one embodiment of outputting a representation of the temporal content profile;

FIG. 6 illustrates a flowchart of a procedure performed by the system of FIG. 2, when the temporal content profile creating process receives a first temporal content having a first content instance and a second content instance, according to one example embodiment disclosed herein;

FIG. 7 illustrates a flowchart of the methods performed by the system of FIG. 2, when the temporal content profile creating process receives a first and second metadata comprising a first ratings data and a second ratings data respectively, according to one example embodiment disclosed herein;

FIG. 8 illustrates a flowchart of the methods performed by the system of FIG. 2, when the temporal content profile creating process receives user generated metadata, according to one example embodiment disclosed herein;

FIG. 9 illustrates a flowchart of a procedure performed by the system of FIG. 2, when the temporal content profile creating process creates a first temporal content profile from the first content instance profile and the second content instance profile, according to one embodiment disclosed herein;

FIG. 10 illustrates a functional flowchart of one embodiment of determining a comparison of a first and a second temporal content;

FIG. 11 illustrates a functional flowchart of one embodiment of determining a comparison of a first, a second and a third temporal content;

FIG. 12 illustrates a flowchart of a procedure performed by the system of FIG. 2, when the temporal content profile creating process receives a representation of a temporal content profile according to one example embodiment disclosed herein;

FIG. 13 illustrates a flowchart of a procedure performed by the system of FIG. 2, when the temporal content profile creating process outputs the representation of the first temporal content profile to a user interface, according to one embodiment disclosed herein;

FIG. 14 illustrates an example user interface depicting a representation of a first, second and third temporal content profile;

FIG. 15 illustrates an example user interface depicting a representation of a first and second temporal content profile along with an audience measure graph region;

FIG. 16 illustrates an example user interface depicting an audience measure graph region depicted as pie charts;

FIG. 17 illustrates an example user interface depicting a representation of a first and second temporal content profile where the representations can be stored and transmitted;

FIG. 18A illustrates an example user interface providing methods of allowing a user to create metadata;

FIG. 18B illustrates an example of a representation of a temporal content profile having segments;

FIG. 19A illustrates an example of a user interface providing methods of allowing a user to select types of comparisons;

FIG. 19B illustrates an example of a user interface providing methods of allowing a user to select time-based comparisons;

FIG. 20A illustrates an example of a user interface providing methods of allowing a user to select types of comparisons;

FIG. 20B illustrates an example of a user interface providing methods of allowing a user to select program-based comparisons; and

FIG. 21 illustrates a functional diagram of one embodiment of a program product.

### DETAILED DESCRIPTION

Systems and methods for creating, managing and comparing a temporal content profile will now be described in detail with reference to the accompanying drawings. It will be appreciated that, while the following description focuses on a system that creates a temporal content profile for use with cable or broadcast television media with ratings data, the systems and methods disclosed herein have wide applicability. For example, the temporal content profile described herein may be used with any type of media such as but not limited to radio, video, broadcast television, cable, movies or Internet together with metadata such as but not limited to ratings data, download data, viewing data or listening data. Notwithstanding the specific example embodiments set forth below, all such variations and modifications that would be envisioned by one of ordinary skill in the art are intended to fall within the scope of this disclosure.

Conventional technologies for matching television ratings data to their respective television programs are limited in that conventional technologies typically require manually mapping various inputs having different formats and deliveries, to the associated ratings in order to produce useful assimilation of the data. These deficiencies create more challenges as the number of television markets, the variety of television programs, commercials, and methods of viewing expand. Embodiments disclosed herein recognize and overcome such deficiencies and provide a system that includes a computer implemented system and/or software executing a temporal content profile creating process that in general receives temporal content and synchronizes the content with metadata to create a temporal content profile.

Attribute as used herein is defined as any type of metadata that may be used to characterize or represent content. For example only, and not for limitation, an attribute may include a descriptor of a segment of a media program such as a commercial, a monologue, a program title, a content type, a demographic or any other data representing content. Other examples of attribute include metadata describing characteristics of the content such as host gender, contributor, story type, lead-in content or general description of the content.

Content as used herein is defined as any type of analog or digital transmission such as but not limited to video, cable, broadcast media, radio, streaming media or on-demand media.

Content profile as used herein is defined as any combination of content with metadata. For example, and not limitation, a content profile for temporal content may be the content at an instance with any metadata associated with that content at that instance. A content profile may also comprise a plurality of instances over a temporal dimension such as time.

Metadata as used herein is defined as any type of data that can be associated with content and includes attributes. Metadata may or may not be within the temporal content and may include metadata defined from the temporal content or may be defined separately. Metadata may be associated with a specific instance of the content or it may be associated with multiple instances of the content. For example only, and not as a limitation, metadata may include data reflecting ratings, average ratings, audience gain, audience loss, gender, presenter name, presenter type, program title, rating type, Designated Market Area (DMA), DMA rank, diary information, date, time-of-day, time-of-program, date, demographic data, demographic rating, channel, station, broadcaster, program type, segments, comments, content type, content date, content start time, content stop time, closed-captioned text, activity type, live or any other attribute. A metadata field is used to categorize the type of metadata and a metadata field value is a value assigned to that metadata field. Some data may be provided by third parties and some metadata may be derived from other metadata. Metadata may comprise a table of data, the table representing one or more metadata fields which may be populated with metadata field values.

A segment as used herein is defined as one or more content instances assigned a similar metadata or attribute. Segments may be manually assigned by a user or segments may be automatically generated from metadata. A segment may be defined by a segment start, a segment end and a segment value.

Ratings data as used herein is defined as any metadata field or metadata field value or other data associated with the popularity, audience, ranking or viewers of temporal content. Ratings data includes but is not limited to audience measures, demographics, audience increase, audience decrease, audience retention, individual retention, competitive rankings and popularity.

Temporal as used herein is defined as any type of sequence or pattern to include sequences and patterns of time. Temporal content as used herein is defined as any type of content that is transmitted over or spans a period of time or other type of sequence or pattern.

Temporal content as used herein is any type of media that has content, or content instances, over a temporal dimension. Temporal content profile may be a single instance or it may represent a plurality of instances. For example, and not for limitation a temporal content may be a single instance, such as a single time-in-program instance, or it may represent a plurality of instances, such as instances over a duration of a media program.

A temporal content profile as used herein is defined as temporal content associated with metadata. A temporal content profile may be a single instance or it may represent a plurality of instances. For example, and not for limitation a temporal content profile may be a single instance, at a single time-in-program, including metadata associated with that instance.

Embodiments disclosed herein include a computer implemented system executing a temporal content profile creating process that receives a first temporal content having a first content instance and a second content instance. In an example embodiment, temporal content is media that has different content over time. The first content instance may represent content at a first point in time, and the second content instance may represent content at a second point in time. The temporal content profile creating process receives a first metadata associated with the first content instance and a second metadata associated with the second content instance. The first metadata may comprise a first ratings data and the second metadata comprises a second ratings data. In another example embodiment, metadata may be any type of data associated with the content or data used to characterize the content.

The temporal content profile creating process creates a first content instance profile by synchronizing the first content instance with the first metadata. The temporal content profile creating process also creates a second content instance profile by synchronizing the second content instance with the second metadata. In an example embodiment, the content instance profile reflects the metadata, and the content associated with that instance. Each point (i.e., content instance) in media, for example, a video, or television program, may have metadata that is associated with that particular point in the media. For example, each point in a video may have ratings data, closed caption text, video name, the time the video aired, the television station airing the video, demographic data, etc.

The temporal content profile creating process then creates a first temporal content profile from the first content instance profile, and the second content instance profile. The temporal content profile in this example reflects a profile across the first and the second instance. This profile may be expanded such that the temporal content profile may be a series of content instance profiles with their associated metadata over a temporal period or temporal dimension.

In some embodiments, the first and second metadata comprises one or more content attributes. In some embodiments, the temporal content profile creating process automatically determines the first content attribute from the first content instance, and the second content attribute from the second content instance. For example, a user may determine where the first content instance and the second content instance points occur. The temporal content profile creating process may then automatically determine the first content attributes from the user defined first content instance, and the second content attributes from the user defined second content attributes. In some embodiments, the user may generate metadata. For example, when the user determines the locations of the first content instance and the second content instance, the user may also add metadata to those respective content instances.

In some example embodiments, the metadata comprises text data. In some embodiments of temporal content, the temporal content is a media program, such as video content, and the text data is a closed caption text data.

In some example embodiments, the metadata may comprise ratings data. Rating data may comprise a ratings field, such as household audience, and a ratings value, such as the specific household audience rating measure. A first ratings data may comprise a first ratings field value, such as a first audience measure, associated with the first content instance, and a second ratings field value, such as a second audience measure, associated with the second content instance. In some embodiments, when the temporal content profile creating process creates the second content instance profile, the temporal content profile creating process may automatically determine an audience change measure between the first audience measure and the second audience measure at the second content instance. Additionally, when the temporal content profile creating process creates the second content instance profile, the temporal content profile creating process may automatically determine a gain audience measure reflecting an increase in the audience change measure. In some embodiments, the temporal content profile creating process may also determine a loss audience measure reflecting a decrease in the audience change measure. For example, each point in the video has metadata reflecting a respective audience measure (i.e., audience rating). The temporal content profile creating process determines a change in audience rating whether that change is an increase in audience viewing or a decrease in audience viewing.

In another example embodiment, the temporal content profile creating process may receive a second temporal content. When the temporal content profile creating process creates the second content instance profile, the temporal content profile creating process may automatically determine a transfer audience measure reflecting a transfer of an audience between the first temporal content, and the second temporal content. For example, the temporal content profile creating process determines the change in audience viewing (i.e., increased audience viewing or decreased audience viewing), and also determines which television stations (or programs) the audience came from, or which television stations (or programs) the audience switched to.

In some example embodiments, the temporal content profile creating process may further comprise storing an alarm trigger. In these embodiments, the temporal content profile creating process may compare the alarm trigger to the temporal content profile and communicate an alarm when the alarm trigger is in the temporal content profile. For example, the alarm trigger may be content contained within a video. Closed-captioned text may represent text data of that content. The temporal content profile creating process compares the alarm to the closed-captioned text. When occurrence of the closed-captioned text within the video triggers the alarm, the temporal content profile creating process communicates the alarm, for example, such as transmitting an email alert.

In some example embodiments, the temporal content profile creating process outputs a representation of the first temporal content profile. The temporal content profile creating process receives a representation of a first temporal content profile comprising a first content instance profile reflecting a content instance synchronized with a metadata. The temporal content profile creating process then outputs the representation of the first temporal content profile to a user interface. For example, the temporal content profile creating process renders the representation of the first temporal profile within a user interface, such as a graphical user interface. In another example embodiment, the temporal content profile creating process outputs a representation of a second temporal content profile to the user interface. In other words, the temporal content profile creating process may render multiple temporal content profiles on a user interface. In other words, users may see multiple videos with accompanying metadata such as closed-captioned text and ratings data on a user interface.

In some example embodiments, the temporal content profile creating process synchronizes the representation of the first temporal content profile with the representation of the second temporal content profile. For example, a user viewing multiple videos with accompanying closed-captioned text and ratings data (i.e., multiple temporal content profiles) on a user interface synchronizes one of the videos to a point in the video, such as one minute into the video. When the user selects a ‘synchronize’ button, the temporal content profile creating process synchronizes each of the multiple videos (i.e., the multiple temporal content profiles) to that same point (i.e., time-in-program such as the one minute mark into each of the videos) on the user interface.

In some example embodiments, the temporal content profile creating process receives a search request and compares the temporal content profile with the search request to define a search result. The temporal content profile creating process then may output the search result to the user interface. For example, a user enters a search request, such as a keyword, or keyword phrase. The temporal content profile creating process compares the search request to the temporal content profile such as metadata comprising closed-captioned text. The temporal content profile creating process then outputs the results of that comparison, for example, outputting video clips that contained closed-captioned text matching the keyword or keyword phrase entered by the user through the search request.

In some example embodiments, the temporal content profile creating process receives user defined metadata, and may synchronize the user defined metadata with one or more content instances or temporal content profiles. For example, the temporal content profile creating process allows the user to enter additional metadata to the temporal content profile. For example, the user may output a temporal content profile on the user interface, and using the user interface, add metadata to the temporal content profile. For example, using a segment editor, the user may create segments within the temporal content profile, and add metadata to each of the segments.

In some example embodiments, the temporal content profile creating process may store the representation of the temporal content profile and transmit the representation of the temporal content profile. For example, the user, using the user interface, may output the temporal content profile and view it as a video with an accompanying graph displaying ratings data. The user may save the representation of the video and the accompanying graph onto the client devices, and later transmit that representation to another user. The user may also be able to select emailing the temporal content profile and any comparisons and email them to another user.

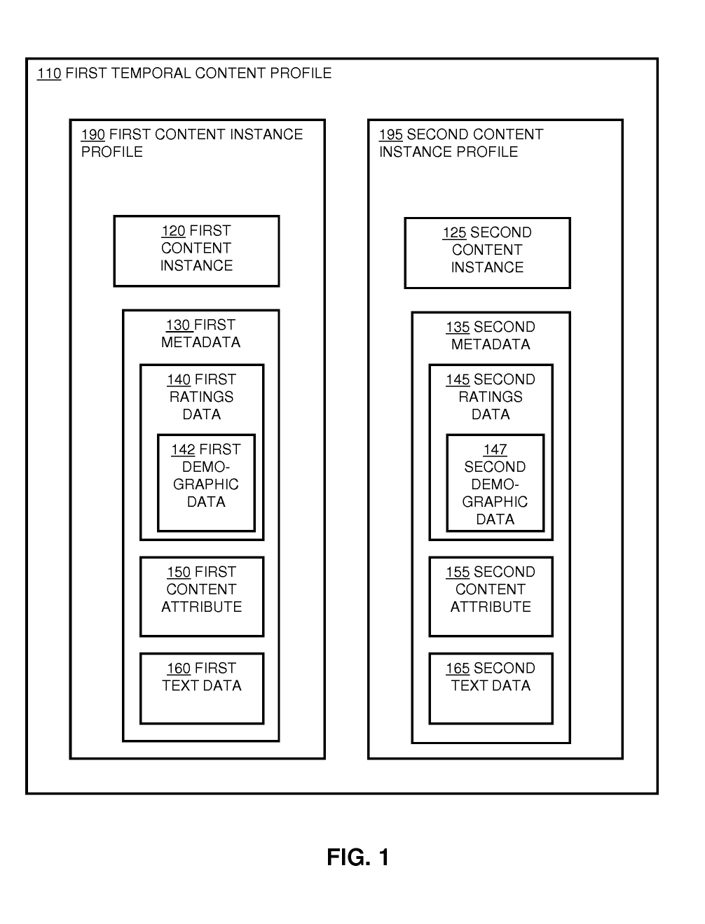

FIG. 1 is a block diagram illustrating an example architecture of a content profile. In this embodiment, the temporal content profile creating process utilizes a first temporal content having a first content instance 120, and a second content instance 125. The temporal content profile creating process also utilizes a first metadata 130 associated with the first content instance 120, and a second metadata 135 associated with the second content instance 125. The first metadata 130 may comprise a first ratings data 140, and the second metadata 135 may comprise a second ratings data 145. In an example embodiment, the first metadata 130 may comprise first content attributes 150, and the second metadata 135 may comprise second content attributes 155. In another example embodiment, the first metadata 130 may comprise first text data 160, and the second metadata 135 may comprise second text data 165. In another example embodiment, the first ratings data 140 may comprise a first demographic data 142, and the second ratings data 145 may comprise a second demographic data 147. With the content instances and metadata, the temporal content profile creating process creates a first content instance profile 190 by synchronizing the first content instance 120 with the first metadata 130. The temporal content profile creating process also creates a second content instance profile 195 by synchronizing the second content instance 125 with the second metadata 135. In this embodiment, the temporal content profile creating process is then able to create a first temporal content profile 110 from the first content instance profile 190 and the second content instance profile 195.

In an example illustrative embodiment of FIG. 1, the temporal content profile 110 may represent a video clip, for example, of a television program and the temporal content profile 110 contains a first content instance 120 representing a moment in time of the television program. The first content instance 120 is synchronized with a first metadata 130. The first metadata 130 contains a first content attribute 150 associated with the first content instance 120. The first content attribute 150 may contain, for example, a name associated with the television program, the time the television program aired, the market in which the television program aired, etc. The first metadata 130 may also contain first ratings data 140, for example, ratings data that were collected during the airing of the television program. The first metadata 130 may also contain first text data 160, such as closed captioned text associated with the first content instance 120.

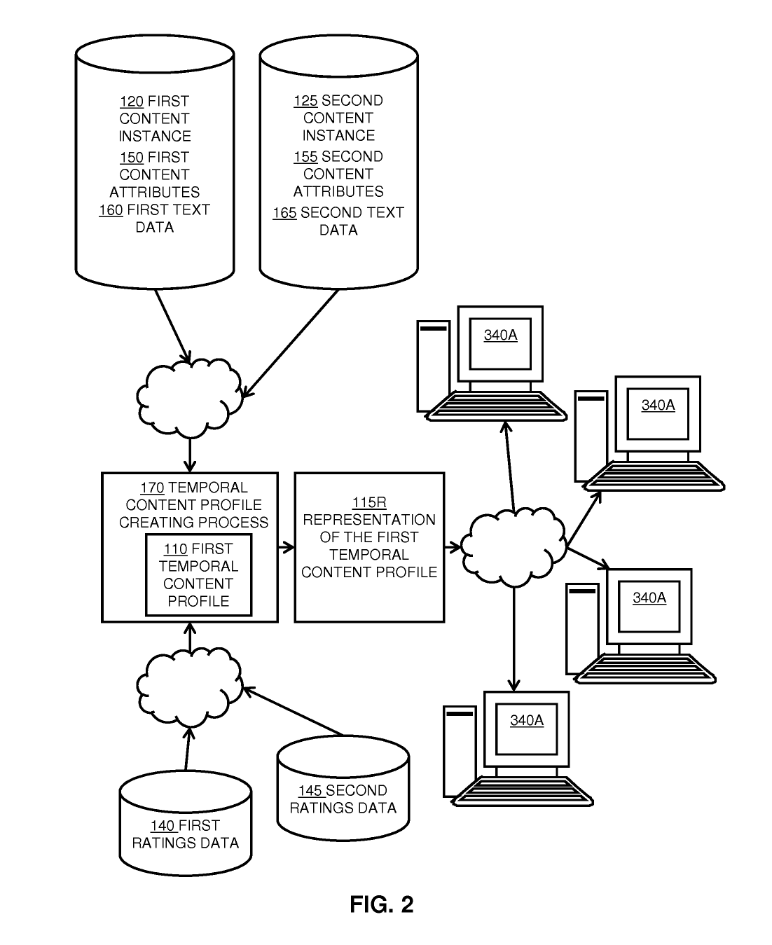

FIG. 2 is a high-level block diagram of a content profiling system according to one example embodiment disclosed herein. The temporal content profile creating process 170 is in communication with content sources so that it can receive a first content instance 120 and a second content instance 125. In an example embodiment, the first content instance 120 and second content instance 125 are received by being in communication with a content provider, such as a television station. The temporal content profile creating process 170 is also in communication with metadata sources so that it can receive metadata such as first content attributes 150 and second content attributes 155, for example, by being in communication with a content provider such as a television station. In an example embodiment, the temporal content profile creating process 170 may also be in communication with metadata sources such as a television station so that it can receive first text data 160 and second text data 165 from a content provider. The temporal content profile creating process 170 may be in communication with metadata sources to receive first ratings data 140 and second ratings data 145 from, for example, a ratings provider. The temporal content profile creating process 170 creates a first temporal content profile 110 as described above and illustrated in FIG. 1, and may communicate a representation of the first temporal content profile 115 to user interfaces 340A such as on a remote client device.

As will be readily apparent to those skilled in the art, systems and methods for creating a temporal content profile can be embodied in hardware, software, or a combination of hardware and software. For example, a computer system or server system, or other computer implemented apparatus combining hardware and software adapted for carrying out the methods described herein, may be suitable. One embodiment of a combination of hardware and software could be a general purpose computer system with a computer program that, when loaded and executed, carries out the respective methods described herein. In some embodiments, a specific use computer, containing specialized hardware for carrying out one or more of the instructions of the computer program, may be utilized. In some embodiments, the computer system may comprise a device such as, but not limited to a digital phone, cellular phone, laptop computer, desktop computer, digital assistant, server or server/client system.

Computer program, software program, program, software or program code in the present context mean any expression, in any language, code or notation, of a set of instructions readable by a processor or computer system, intended to cause a system having an information processing capability to perform a particular function or bring about a certain result either directly or after either or both of the following: (a) conversion to another language, code or notation; and (b) reproduction in a different material form. A computer program can be written in any form of programming language, including compiled or interpreted languages, and it can be deployed in any form, including as a stand-alone program or as a module, component, subroutine, or other unit suitable for use in a computing environment.

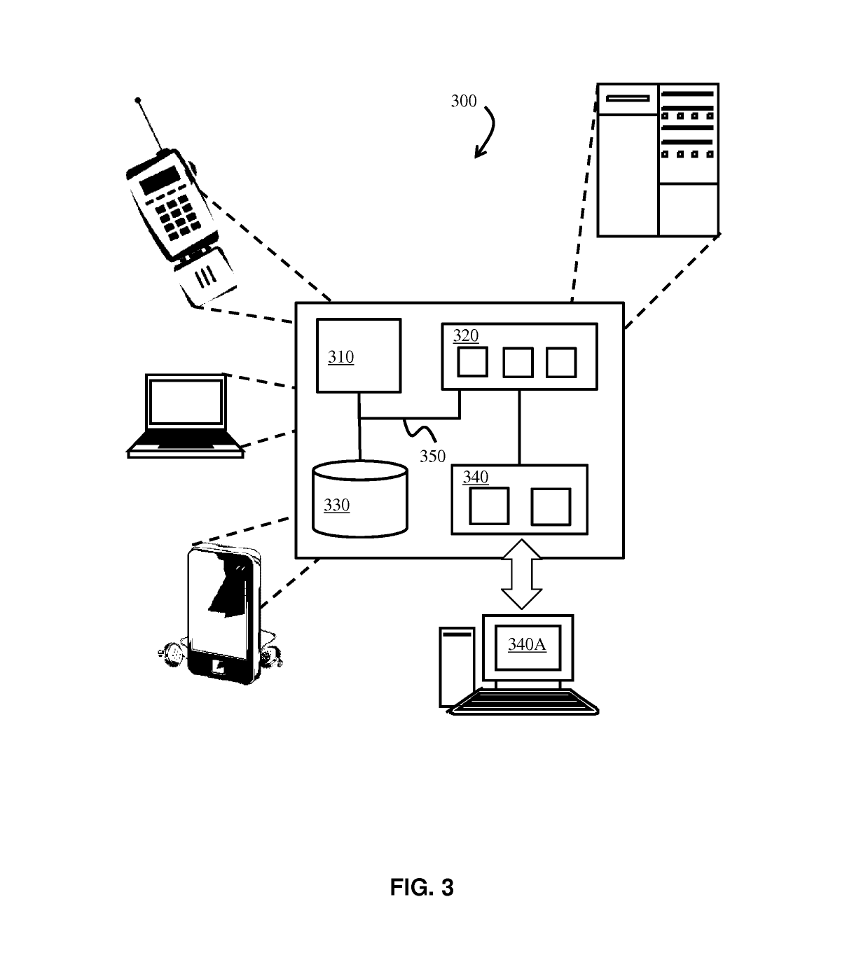

FIG. 3 is a schematic diagram of one embodiment of a computer system 300 by which the environmental system reaction methods may be carried out. The computer system 300 can be used for the operations described in association with any of the computer implemented methods described herein. The computer system 300 includes at least one processor 310, a memory 320 and an input/output device 340. Each of the components 310, 320, and 340 are operably coupled or interconnected using a system bus 350. The computer system 300 may further comprise a storage device 330 operably coupled or interconnected with the system bus 350.

The processor 310 is capable of receiving the instructions and/or data and processing the instructions of a computer program for execution within the computer system 300. In some embodiments, the processor 310 is a single-threaded processor. In some embodiments, the processor 310 is a multi-threaded processor. The processor 310 is capable of processing instructions of a computer stored in the memory 320 or on the storage device 330 to communicate information to the input/output device 340. Suitable processors for the execution of the computer program instruction include, by way of example, both general and special purpose microprocessors, and a sole processor or one of multiple processors of any kind of computer.

The memory 320 stores information within the computer system 300. Memory 320 may comprise a magnetic disk such as an internal hard disk or removable disk; a magneto-optical disk; an optical disk; or a semiconductor memory device such as PROM, EPROM, EEPROM or a flash memory device. In some embodiments, the memory 320 comprises a transitory or non-transitory computer readable medium. In some embodiments, the memory 320 is a volatile memory unit. In another embodiment, the memory 320 is a non-volatile memory unit.

The processor 310 and the memory 320 can be supplemented by, or incorporated in, ASICs (application-specific integrated circuits).

The storage device 330 may be capable of providing mass storage for the system 300. In various embodiments, the storage device 330 may be, for example only and not for limitation, a computer readable medium such as a floppy disk, a hard disk, an optical disk, a tape device, CD-ROM and DVD-ROM disks, alone or with a device to read the computer readable medium, or any other means known to the skilled artisan for providing the computer program to the computer system for execution thereby. In some embodiments, the storage device 330 comprises a transitory or non-transitory computer readable medium.

In some embodiments, the memory 320 and/or the storage device 330 may be located on a remote system such as a server system, coupled to the processor 310 via a network interface, such as an Ethernet interface.

The input/output device 340 provides input/output operations for the system 300 and may be in communication with a user interface 340A as shown. In one embodiment, the input/output device 340 includes a keyboard and/or pointing device. In some embodiments, the input/output device 340 includes a display unit for displaying graphical user interfaces or the input/output device 340 may comprise a touchscreen. In some embodiments, the user interface 340A comprises devices such as, but not limited to a keyboard, pointing device, display device or a touchscreen that provides a user with the ability to communicate with the input/output device 340.

The computer system 300 can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, wireless phone networks and the computers and networks forming the Internet.

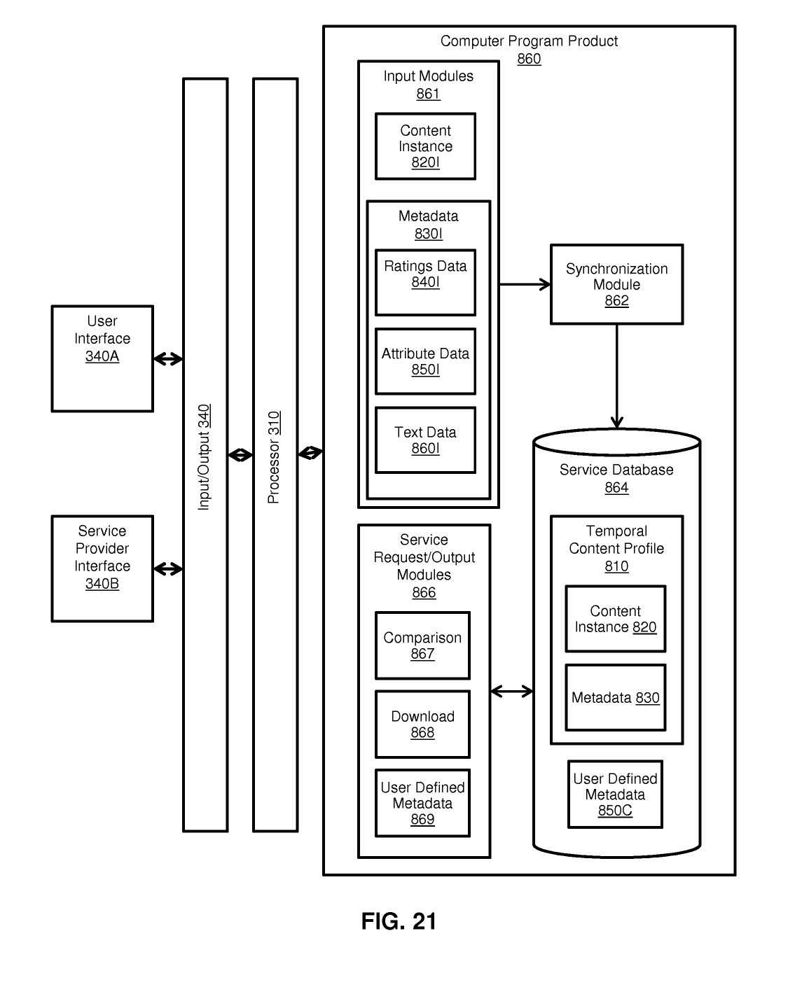

A functional diagram of one embodiment of the computer program capable of executing the described methods is shown in the functional diagram in FIG. 21. As shown, computer program product 860 is capable of interfacing with the computer system processor 310 and the input/output device 340 which in turn are able to communicate with user interface 3240A and service provider interface 340B. In this embodiment, computer program product 860 generally comprises input modules 861, a synchronization module 862, a service database 864 and service request/output modules 866. The input modules 861 communicate the system interfaces to the user allowing them to input data and the system to receive the data. These input modules 861 may include a content instance input module 820I to receive content instances and metadata input modules 830I to receive metadata. The metadata modules 830I may comprise ratings data input module 840I to receive rating data, an attribute data input module 850I to receive attribute data and a text data input module 860I to receive text data. The input modules 861 are configured to communicate this input data to the synchronization module 862 which synchronizes the metadata with the content instances to create the temporal content instance. The service database 864 stores the temporal content profile 810 which may comprise content instances 820 and metadata 830. The service database 864 may also store user defined metadata 850C for subsequent download or synchronization with temporal content profile data 810. The computer program product also may comprise service request/output modules 866. The service request/output modules 866 receive service requests, execute the methods associated with the request and output the results. These modules may comprise a comparison module 867, a download module 868 and user defined metadata module. The comparison module 867 communicates the system interfaces to the user that allows them to define metadata fields and values for comparison. The comparison module 867 receives a request from these interfaces for comparing metadata from a temporal content profile and performs the synchronization and comparison on the metadata as described herein and provides the results for display on the user interface. The download module 868 communicates the system interfaces to the user that allows them to request a download of metadata, such as user defined metadata or other selected metadata, and then communicates the result for use by the user interface 304A or the service provider interface 340B. The user defined metadata module 869 communicates the system interfaces to the user that allows them to select metadata fields and input field values for storage as user defined metadata 850C. The user defined metadata module 869 also receives the metadata, such as segment data and transmits it to the service database 864 for storage or use as user defined metadata 850C.

In some embodiments, the computer program for execution within the computer system may utilize specific computer program tools such as Microsoft's Silverlight for presentation of metadata, temporal content and temporal content profiles to users through the user interface such as through a web browser.

Further details of configurations explained herein will now be provided with respect to a flow chart of processing steps that show the high level operations disclosed herein to perform the temporal content profile creating process 170.

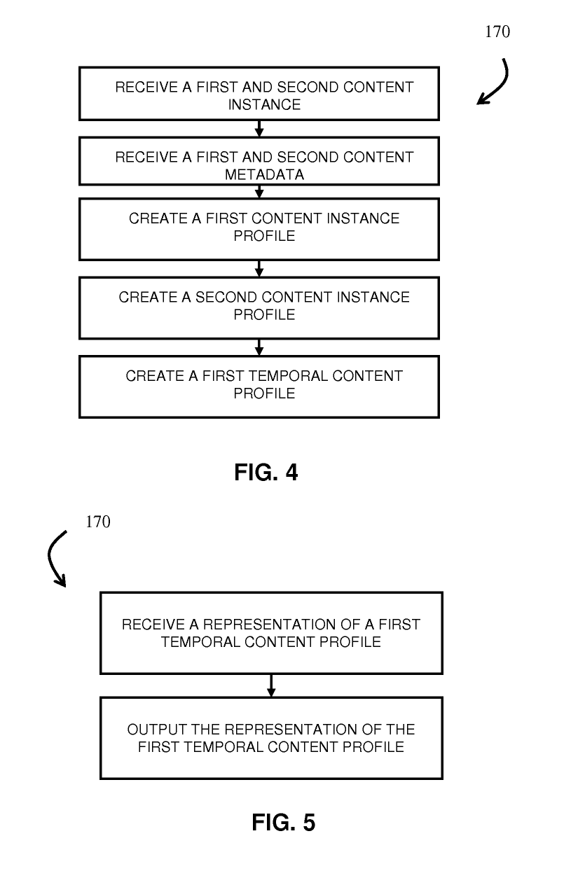

FIG. 4 is a high level example embodiment of the steps performed by the temporal content profile creating process 170 when it creates a temporal content profile from a first temporal content. In an example embodiment, the temporal content profile creating process 170 creates a first content instance profile 190 after receiving a first content instance 120 and a first metadata 130. The temporal content profile creating process 170 also creates a second content instance profile 195 after receiving a second content instance 125 and a second metadata 135. Using the first content instance profile 190 and the second content instance profile 195, the temporal content profile creating process 170 creates the first temporal content profile 110.

FIG. 5 is a high level example embodiment of the steps performed by the temporal content profile creating process 170 when it outputs a representation of the temporal content profile. The temporal content profile creating process 170 receives a representation of the first temporal content profile 115 and outputs that representation. In an example embodiment, the temporal content profile creating process 170 outputs the representation of the first temporal content profile 115 to a user interface 340A. It is understood that the representation of the temporal content profile may include either all of the temporal content profile information or it may include only selected portions of the temporal content profile.

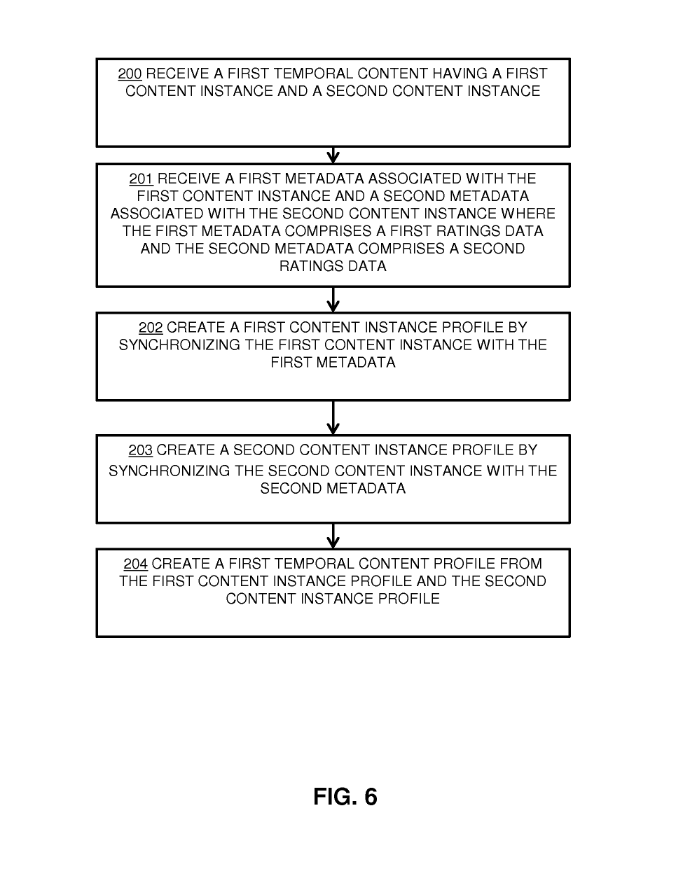

FIG. 6 is an embodiment of the steps performed by the temporal content profile creating process 170 when it receives a first temporal content having a first content instance 120 and a second content instance 125.

In step 200 of FIG. 6, the temporal content profile creating process 170 receives a first temporal content having a first content instance 120 and a second content instance 125. In an example embodiment, the first temporal content is media that has different content over time. The first content instance 120 may represent content at a first point in time, and the second content instance 125 represent content second point in time. For example, the first temporal content may be a video clip, such as a television program, where the first content instance 120 may be the start of a television program section, and the second content instance 125 may be the end of the television program section, right before the first commercial break.

In step 201, the temporal content profile creating process 170 receives a first metadata 130 associated with the first content instance 120, and a second metadata 135 associated with the second content instance 125. The metadata may be any type of data. As shown, the first metadata 130 may comprise a first ratings data 140 and the second metadata 135 may comprise a second ratings data 145. In an example embodiment, the first metadata 130 and the second metadata 135 may be any type of data associated with the content. In another example embodiment, the first metadata 130 and the second metadata 135 may be ratings data associated with television program. For example, as noted in step 201, the first ratings data 140 may be ratings data associated with the start of a television program section and the second ratings data 145 may be ratings data associated with the end of the television program section right before the first commercial break.

In step 202, the temporal content profile creating process 170 creates a first content instance profile 190 by synchronizing the first content instance 120 with the first metadata 130. In an example embodiment, the temporal content profile creating process 170 creates a first content instance profile 190 by synchronizing the first content instance 120 with the first metadata 130, such as first ratings data 140. In other words, the temporal content profile creating process 170 synchronizes the media content at a first point in time with metadata also associated with that first point in time. Although synchronization is described as being performed based on synchronizing content with metadata by time, it is specifically anticipated that synchronization may be done based on other criteria such as other metadata content.

Means for synchronizing content and metadata may comprise any method of comparing content and/or metadata of a content instance to properly match or align metadata with its associated content. For example, to synchronize metadata with content, when metadata comprises metadata field and values, synchronizing may comprise assigning those metadata fields and values associated with the content instance to that specific content instance.

In step 203, the temporal content profile creating process 170 creates a second content instance profile 195 by synchronizing the second content instance 125 with the second metadata 135. In an example embodiment, as shown in FIG. 1, the second metadata 135 may be comprised of second ratings data 145, second content attributes 155 and/or second text data 165. The temporal content profile creating process 170 synchronizes the second content instance 125 with the second metadata 135 to create the second content instance profile 195.

In step 204, the temporal content profile creating process 170 creates a first temporal content profile 110 from the first content instance profile 190 and the second content instance profile 195. In an example embodiment, the first temporal content profile 110 may be comprised of a plurality of content instance profiles. In other words, a video clip may be comprised of multiple content instance profiles for every point in time on the video clip. The first temporal content profile 110 is a series of content instance profiles over a period of time.

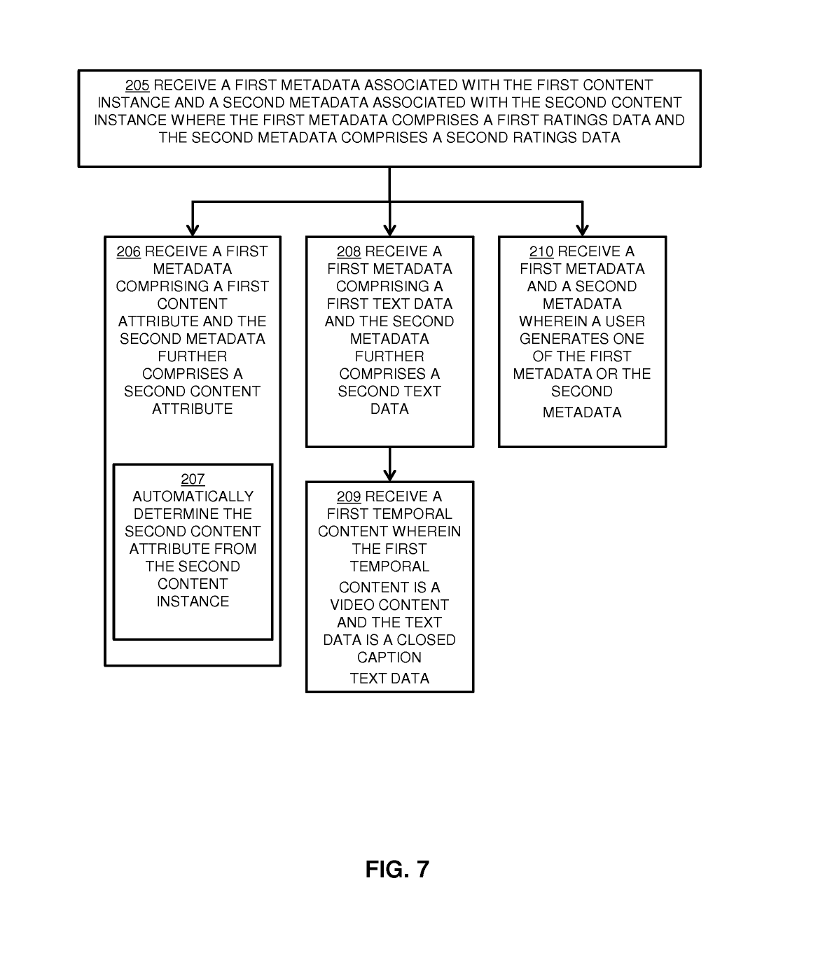

FIG. 7 is an example embodiment of steps performed by the temporal content profile creating process 170 of FIG. 6 when the first metadata 130 further comprises a first content attribute 150 and the second metadata 135 further comprises a second content attribute 155.

In this embodiment, at step 205, the temporal content profile creating process 170 receives a first metadata 130 associated with the first content instance 120, and a second metadata 135 associated with the second content instance 125 where the first metadata 130 comprises a first ratings data 140 and the second metadata 135 comprises a second ratings data 145. In an example embodiment, the first ratings data 140 and second ratings data 145 may be ratings data associated with media content, such as a television program. The ratings data, such as how many homes tuned into that television program, the demographic data associated with those viewers, etc., may have been captured, for example, by a ratings provider, at the time the media content aired over a television or cable station.

In step 206, the temporal content profile creating process 170 receives a first metadata 130 further comprising a first content attributes 150 and the second metadata 135 further comprising a second content attributes 155. In an example embodiment, the first content attributes 150 may be information associated with the content media. For example, if the content media is a television program, the first content attributes 150 may include information such as the television station that aired the television program, the time the television program aired, the name of the television program, the time zone in which the television program aired, etc.

In step 207, the temporal content profile creating process 170 may automatically determine the second content attributes 155 from the second content instance 125 or with other second metadata associated with that second content instance. In an example embodiment, the first temporal content may be divided into segments. Each content instance, such as the second content instance 125, may have metadata such as content attributes that may include segment information such as whether that second content instance 125 is the beginning or the end of a particular segment. The temporal content profile creating process 170 may automatically determine the segment information (i.e., the second content attributes 155) from the second content instance 125 or second metadata. In some embodiments, the temporal content profile creating process may automatically determine other types of metadata, not just content attributes, from a content instance or metadata.

FIG. 7 further illustrates an example embodiment of steps performed by the temporal content profile creating process 170 when the metadata further comprises a text data, which may be a closed caption text data, or the metadata further comprises metadata generated by a user. Although these steps are shown in a sequence, they may be performed in any sequence and some steps may not be performed at all.

In step 208, the temporal content profile creating process 170 receives a first metadata 130 comprising a first text data 160, and the second metadata 135 comprising a second text data 165. As shown in the embodiment of FIG. 1, the first metadata 130 may comprise first ratings data 140, first content attributes 150, and/or first text data 160. Likewise, the second metadata 135 may comprise second ratings data 145, second content attributes 155, and/or second text data 165.

In step 209, the temporal content profile creating process 170 receives a first temporal content wherein the first temporal content is a media program, such as video content, and the text data is a closed caption text data. In an example embodiment, the temporal content is a television program. The first metadata 130 and the second metadata 135 may include text data such as closed-captioned text data that accompanies the television program. The first metadata 130 is the closed caption text data that occurs at the point in time where the first content instance 120 occurs.

In step 210, the temporal content profile creating process 170 receives a first metadata 130 and a second metadata 135 where a user generates one of the first metadata 130 or the second metadata 135. In an example embodiment, a user may create segments associate with the temporal content. The temporal content profile creating process 170 allows the user to add first metadata 130 or second metadata 135 to the content instance profiles (i.e., the first content instance profile 190 or the second content instance profile 195) within the temporal content. For example, the user may create segments reflecting different portions of the content via one or more log sheets defining metadata fields and values such as the segment start (beginning) and segment end (stop) of the segment and may include a segment value (description) of the segment. In some embodiments, the user generate metadata is maintained as user generated metadata, separate from the content instance profile, for later synchronization or comparison with the temporal content profile or the metadata. User generated metadata may be associated with a particular user or associated with a group to which that the user belongs. The log sheets may also be provided to the temporal content profile creating process 170 electronically such as through a data spreadsheet (log sheet) having metadata fields and metadata values. The temporal content profile creating process 170 parses the log sheets utilizing the metadata fields and metadata values, and obtains the first metadata 130 and second metadata 135 from the user provided log sheets. A request to output the segment may then be received which synchronizes the uploaded segment start, the segment end and the segment value with the first metadata or the temporal content profile and outputs the segment start, the segment end, the segment value and the first metadata whereby the segment start, the segment end, the segment value and the first metadata can be displayed in a user interface. In some embodiments, the metadata may be displayed in an Excel macro on the user's remote client.

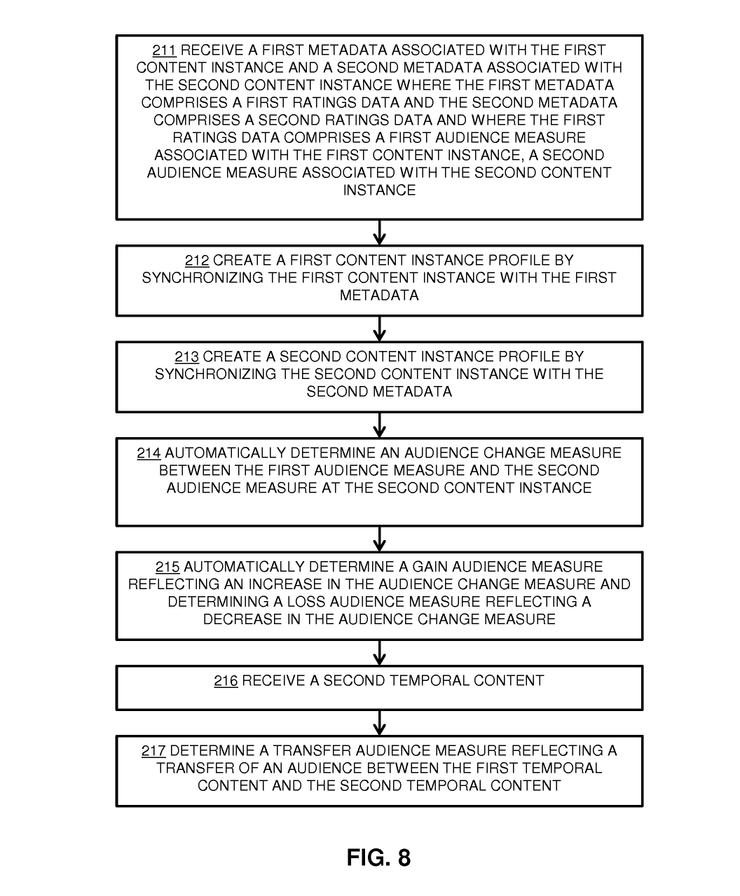

FIG. 8 is an example embodiment of the steps performed by temporal content profile creating process 170 when it receives a first metadata 130 associated with the first content instance 120, a second metadata 135 associated with the second content instance 125 and may automatically determine statistics or measures from that metadata.

In step 211 of this example embodiment, the temporal content profile creating process 170 receives a first metadata 130 associated with the first content instance 120 and a second metadata 135 associated with the second content instance 125. The first metadata 130 may comprise a first ratings data 140, and the second metadata 135 may comprise a second ratings data 145. The first ratings data 140 may comprise a first audience measure associated with the first content instance 120 and a second audience measure associated with the second content instance 125. In an example embodiment, the first content instance 120 and the second content instance 125 represent moments in time within a television video section. The first ratings data 140 may include a first audience measure, for example, indicating how much of an audience share that television video section received at the first content instance 120, and also a second audience measure indicating how much of an audience share the television video section received at the second content instance 125.

In step 212, the temporal content profile creating process 170 creates a first content instance profile 190 by synchronizing the first content instance 120 with the first metadata 130. In an example embodiment, the temporal content profile creating process 170 creates a first content instance profile 190 by synchronizing the first content instance 120 with the first metadata 130, such as first ratings data 140. In other words, the temporal content profile creating process 170 synchronizes the media content at a first point in time with the metadata that is also associated with that first point in time.

In step 213, the temporal content profile creating process 170 creates a second content instance profile 195 by synchronizing the second content instance 125 with the second metadata 135. In an example embodiment, as shown in FIG. 1, the second metadata may be comprised of second ratings data, second content attributes and/or second text data. The temporal content profile creating process synchronizes the second content instance 125 with the second metadata 135 to create the second content instance profile 195.

In step 214, the temporal content profile creating process automatically determines an audience change measure between the first audience measure and the second audience measure at the second content instance. In an example embodiment, the first content instance and second content instance represent a section of a video program over a period of time. The temporal content profile creating process automatically determines a change in audience viewing between the first content instance and the second content instance as the audience change measure.

In step 215, the temporal content profile creating process 170 may automatically determine a gain audience measure reflecting an increase in the audience change measure. The temporal content profile creating process 170 may also determines a loss audience measure reflecting a decrease in the audience change measure. In an example embodiment, the temporal content profile creating process 170 automatically determines whether the section of a video program lost audience share, or gained audience share.

In step 216, the temporal content profile creating process 170 receives a second temporal content. In an example embodiment, the first temporal content is a section of a television video program from a first television station, and the second temporal content is a section of a television program from a second television station.

In step 217, the temporal content profile creating process 170 determines a transfer audience measure reflecting a transfer of an audience between the first temporal content and the second temporal content. In an example embodiment, the temporal content profile creating process 170 determines what measure of audience viewers left a first television station (i.e., the television station airing the first temporal content) to go to a second television station (i.e., the television station airing the second temporal content). In another example embodiment, the audience measure may reflect two competing televisions stations, two different television markets, the same television program airing during a different time slot, different time zone, different market, etc.

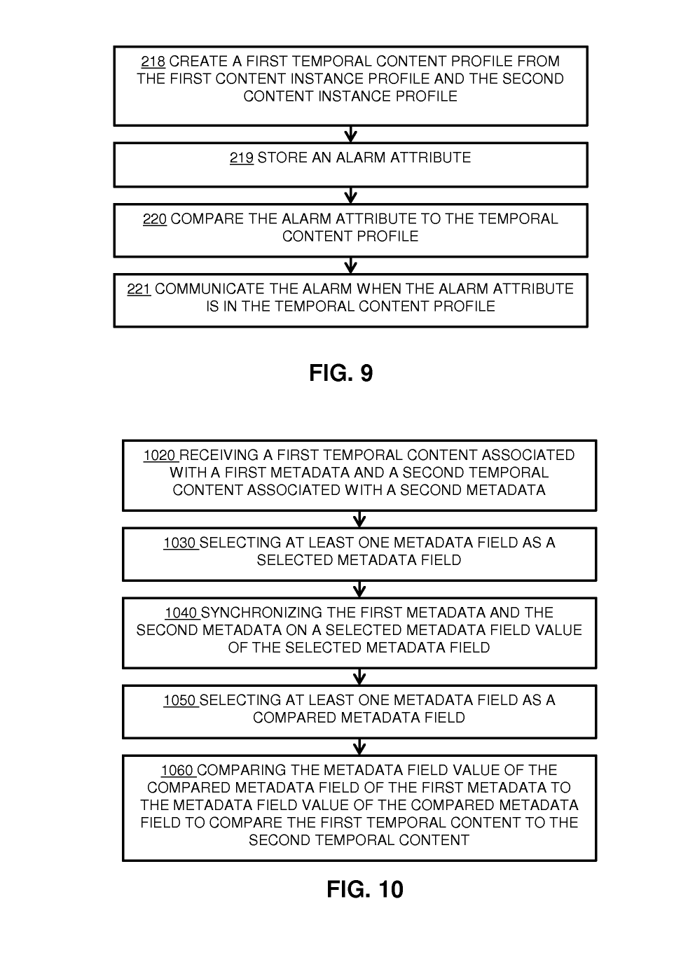

FIG. 9 is an embodiment of the steps performed by temporal content profile creating process 170 when it creates a first temporal content profile 110 from the first content instance profile 190, and the second content instance profile 195 and the metadata may further comprises alarm trigger that may be used to alarm when it is present in the temporal content profile.

In step 218 of this example embodiment, the temporal content profile creating process 170 creates a first temporal content profile 110 from the first content instance profile 190, and the second content instance profile 195. In an example embodiment, the first temporal content profile 110 may be comprised of a plurality of content instance profiles. In other words, a video section may be comprised of multiple content instance profiles for every point in time on the video section. The first temporal content profile 110 is a series of content instance profiles over a period of time.

In step 219, the temporal content profile creating process 170 stores an alarm trigger. In an example embodiment, a user specifies an alarm or a trigger, such as a keyword or keyword phrase that the user wishes to be notified of when that keyword or keyword phase occurs within a television program.

In step 220, the temporal content profile creating process 170 compares the alarm trigger to the temporal content profile. In an example embodiment, the temporal content profile creating process 170 compares the text data, such as the closed-caption text data within the first temporal content profile 110 with the alarm trigger (i.e., the keyword or keyword phrased specified by a user).

In step 221, the temporal content profile creating process 170 communicates the alarm when the alarm trigger is in the temporal content profile. In an example embodiment, when the temporal content profile creating process 170 identifies the alarm trigger such as a keyword or keyword phrase within the closed captioned text data of a television program, the temporal content profile creating process 170 sends the user an alarm such as an email alert.

FIG. 10 illustrates one example embodiment of a computer implemented method of a providing a comparison of temporal content. 1020 comprises receiving a first temporal content and a second temporal content. In this embodiment, the first temporal content may be associated with a first metadata and the second temporal content associated with a second metadata and the first metadata and the second metadata comprising at least one metadata field having at least one metadata field value. 1030 comprises selecting at least one metadata field as a selected metadata field. 1040 comprises synchronizing the first metadata and the second metadata on a selected metadata field value of the selected metadata field. 1050 comprises selecting at least one metadata field as a compared metadata field. With the metadata synchronized on the selected metadata field value, 1060 comprises comparing the metadata field value of the compared metadata field of the first metadata to the metadata field value of the compared metadata field to compare the first temporal content to the second temporal content.

In some embodiments, the definition of metadata fields, which may be populated with metadata field values, provides the ability for the systems and methods for creating a temporal content profile to synchronize and compare content and metadata in different ways. For example, as described below, content and metadata may be synchronized and compared based on the metadata fields such as program, time, date, segment and any other metadata field or metadata field value. For example, synchronizing content instance profiles on the metadata field of program provides program based comparisons and synchronizing content instance profiles on the metadata field of time, whether time such as date, time-in-program or time-of-day, provide time based comparison. By providing a user interface that allows users to select the type of comparison they want to do, they can select either time based or program based comparisons based on the same source of metadata. Means for synchronizing content, metadata and temporal content profiles may comprise any method of comparing content and/or metadata of a content instance to provide a common selected metadata field across content and metadata of a temporal content profile while the other content and metadata maintains its normal association with the content instance. For example, to synchronize metadata when metadata comprises a table of metadata fields and values, synchronizing may comprise comparing metadata fields or values and selecting one or more of the fields or values as a selected field or value and determining metadata having metadata fields or values that match the selected field or value whereby the other metadata fields or values may be compared to each other. Means for synchronizing may comprise comparing metadata fields and selecting all temporal content having the same metadata field. For example, metadata fields as a table of fields may be compared to find similar fields and that metadata is selected as selected field to synchronize the other metadata. An illustration of this may comprise selecting content having a metadata field of program type, content matching that field is then selected and the other metadata of that content is compared according to the selected metadata field. Means for synchronizing may also comprise comparing the metadata field values as a table of values, selecting all content instances with that metadata field value and have all the other metadata fields maintain their relationship their content instance. For example, multiple video contents may be synchronized on a time-in-program value so that the other metadata values, such as ratings data, for one video content can be compared to another according to the same time-in-program. As another example, multiple video contents may be synchronized on a program title value so that the other metadata values, such as ratings data, for one video content can be compared to another video content according to the same program.

One example embodiment of a time based method of comparison can help illustrate embodiments of determining a comparison of temporal content. Referring again to FIG. 10, the first and second temporal content may comprise a media program such as a video program or a broadcast television program and at 1020, this content is received. This temporal content may be associated with metadata fields that reflect any characterization of data related to that temporal content. These metadata fields may include, but are not limited to fields such as time-in-program, time-of-day, demographic, ratings, program, broadcaster, television channel, broadcaster type, user provided fields, segment information any other attributes reflecting the temporal content. These metadata fields may be populated with metadata field values such as the time-of-day may be the specific times that program is being broadcasted, ratings values may be the audience measure watching the program, demographics may be have a value of the age of the audience measure, segment information may be a text description of an attribute of that instance in the media program. At 1030, the user may select the field of time-of-day as the selected metadata field upon which the media programs are synchronized at 1040. In this embodiment, synchronization is aligning the media programs so that the content instances align and the metadata for both temporal contents align based on the time-in-program field across time-of-day values. With the temporal content synchronized, other metadata fields may be compared. For example, at a time-of-day field value of ten minutes after 6 PM EST from the time-of-day field, if ratings is selected as the compared metadata field, the ratings value of the first temporal content can be compared with the ratings value of the second temporal content. This specific comparison may reflect the ratings of two different media channels/outlets at the same time of day. In some embodiments, the selected metadata field may be more than one field. For example, building on the example described, if multiple temporal content is received reflecting the broadcast content of several broadcasters, if a program field was also selected as a selected metadata field, the temporal content would be synchronized on time-of-day and program and the comparison of ratings would be made best on similar programs at similar times of the day. It is understood that the selected metadata fields and values could be any of the metadata fields and field values to include multiple selected metadata fields such as those representing the time-of-day, the time-in-program, the channel, the program, the segment and the demographic. The compared metadata field may also be any of the metadata fields.

Another example embodiment of a program based comparison can help illustrate methods of determining a comparison of temporal content. Again referring to FIG. 10, at 1020, temporal content such as media content may be received. At 1030, the user may select the field of program as the selected metadata field upon which the media programs are synchronized at 1040. In this embodiment, synchronization is aligning the media programs so that similar programs align and the metadata for both temporal contents align based on the program field across program values. With the temporal content synchronized, other metadata fields may be compared. For example, at a program field value of Evening News, if ratings is selected as the compared metadata field, the ratings of the first temporal content can be compared with the ratings of the second temporal content for the Evening News programs. This specific comparison may reflect the ratings of two different media channels/outlets during the program. In some embodiments, the selected metadata field may be more than one field. For example, building on the example described, if multiple temporal content is received reflecting the broadcast content of several broadcasters, if a demographic field was also selected as a selected metadata field, the temporal content could be synchronized on demographic field values and program values and the comparison of ratings would be made best on similar programs for similar demographics. It is understood that the selected metadata fields and values could be any of the metadata fields and field values to include multiple selected metadata fields and values such as those representing the program, the time-in-program, the channel, the segment and the demographic. The compared metadata field may also be any of the metadata fields.

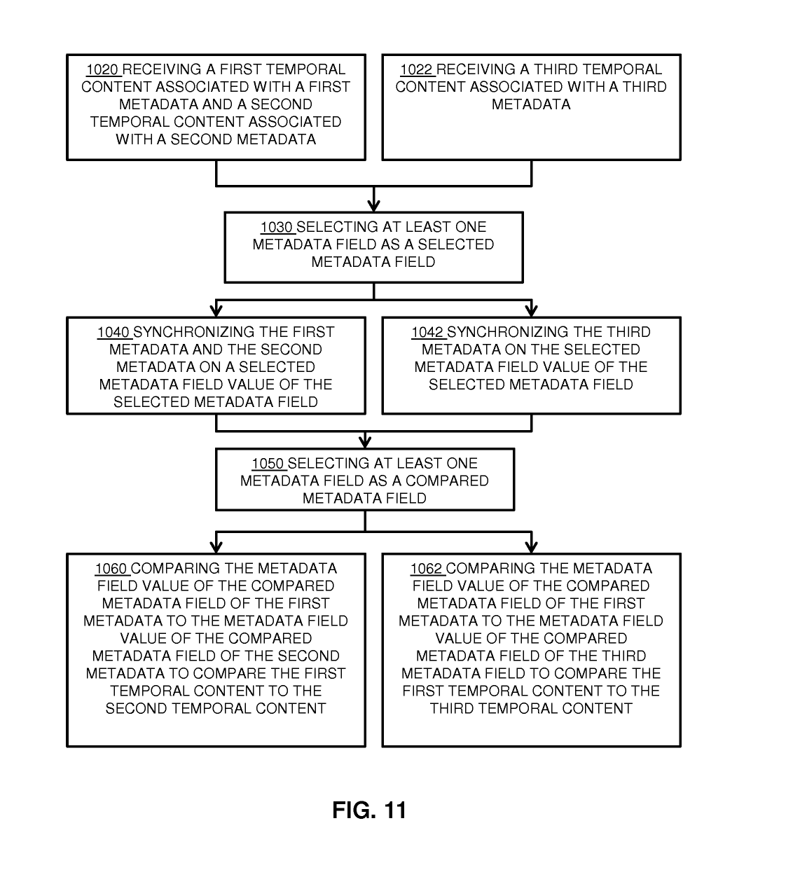

As described above, and as shown in FIG. 11, embodiments of methods of determining a comparison of temporal content may further comprise receiving a third temporal contents and compare the first temporal content to the second temporal content and the third temporal content. The method further comprises receiving a third temporal content associated with a third metadata at 1022. The third metadata comprising one or more metadata fields having one or more metadata field values. At 1042, the method further comprises synchronizing the third metadata on the selected metadata field value of the selected metadata field. And at 1062, the method further comprises comparing the metadata field value of the compared metadata field of the first metadata to the metadata field value of the compared metadata field to compare the first temporal content to the second temporal content and the third temporal content.

As an illustrative example of an embodiment of methods of determining a comparison of temporal content, referring again to FIG. 11, the temporal content may comprise three, four or more media content from different broadcasters. Some embodiments of the methods of determining a comparison of temporal content may receive hundreds of media content and synchronize and display comparisons of ten temporal content profiles on a single user interface.

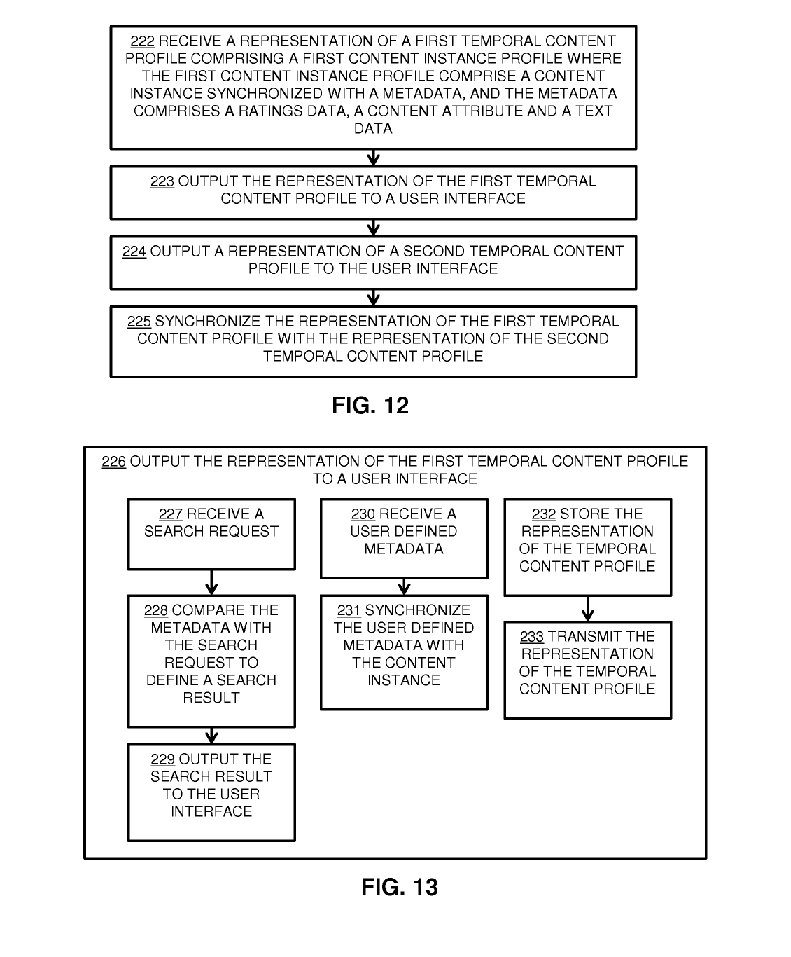

FIG. 12 is an embodiment of the steps performed by temporal content profile creating process 170 when it receives a representation of a first temporal content profile 110. For example, this example embodiment illustrates the process of receiving the results of steps of the temporal content profile creating process at an output device such as a user interface.

In step 222, the temporal content profile creating process 170 receives a representation of a first temporal content profile 110 comprising a first content instance profile 190. As depicted in FIG. 1, the first content instance profile 190 comprises a content instance synchronized with a respective metadata, and the metadata comprises data such as ratings data, content attribute and/or text data. It is understood, that in this embodiment, the representation of the first temporal content profile 110 may be a representation of all or of only a portion of the first temporal content profile. It is also understood that the representation may be of any type that may communicate the data desired of the profile.

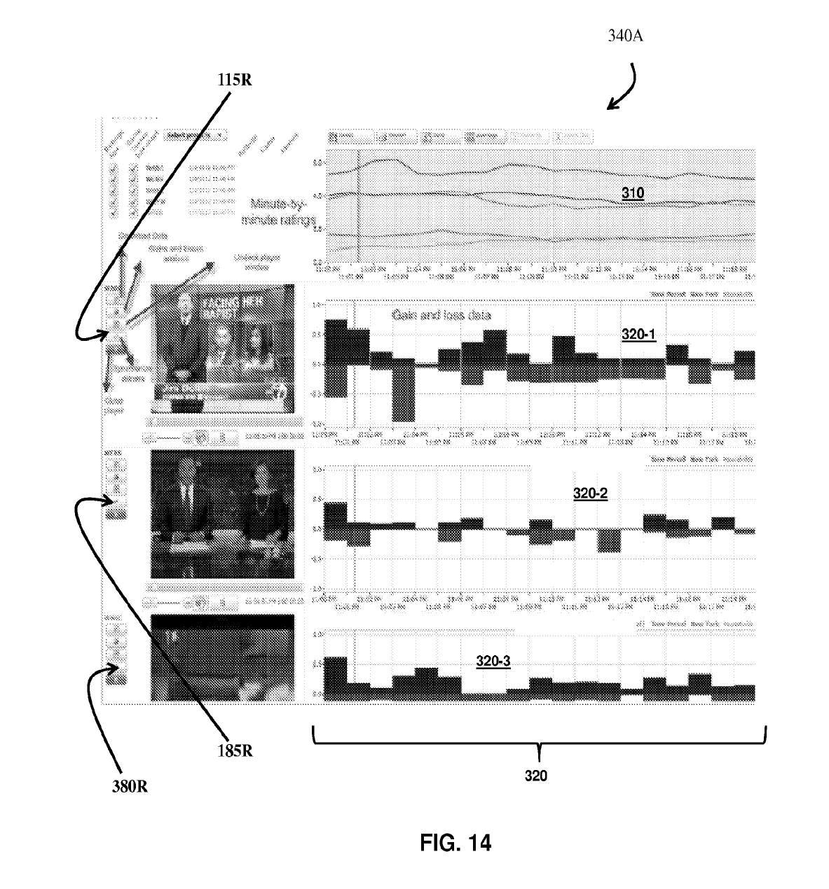

In step 223, the temporal content profile creating process 170 outputs the representation of the first temporal content profile 115 to a device such as a user interface 340A. In an example embodiment, as depicted in FIG. 14, the representation of the first temporal content profile 115 may be depicted as a graph showing ratings data over the course of time, along with an interactive thumbnail video clip of the temporal content associated with that first temporal content profile 110.

In step 224, the temporal content profile creating process 170 outputs a representation of a second temporal content profile 180 to a device such as the user interface 340A. In an example embodiment, the temporal content profile creating process 170 may render multiple representations of temporal content profiles (i.e., the representation of the first temporal content profile 115, the representation of the second temporal content profile 185, and the representation of the third temporal content profile 380R) on the user interface 340A as depicted in FIG. 14. Users may compare the ratings data among the representation of the first temporal content profile 115, the representation of the second temporal content profile 185, and the representation of the third temporal content profile 300, for example, at the same point in time or at some other point of synchronization.

Means to compare comprises any method of comparing a field or value to identify similarities or differences. For example, and not for limitation, means to compare may comprise visually looking at an interface and comparing data in a graph, table, spreadsheet, graphic or other means of displaying information. Means to compare may also comprise mathematical comparisons of numeric metadata or literal comparisons of text metadata or semantic comparisons of text metadata. Means to compare may also comprise performing mathematical calculations on metadata from different content and communicating the results of the calculation.

In step 225, the temporal content profile creating process 170 synchronizes the representation of the first temporal content profile 115 with the representation of the second temporal content profile 185. In an example embodiment, as depicted in FIG. 14, a user displays several representations of the temporal content profiles (i.e., the representation of the first temporal content profile 115, the representation of the second temporal content profile 185, and the representation of the third temporal content profile 300) on the user interface 340A. The user may choose to view ratings data at a particular point in time within one of the temporal content profiles, for example, the first temporal content profile 110. In this embodiment, when the user selects a “Synchronize” button, the temporal content profile creating process 170 synchronizes each of the representations of the temporal content profiles to a particular metadata, such as that particular point in time selected within the first temporal content profile 110. In this embodiment, the user can view and compare, for example, ratings data in a plurality of temporal content profiles at the same point in time within all of those temporal content profiles without having to manually synchronize each of the temporal content profiles to that particular point in time.

As described above, synchronization may be done based on different metadata. For example multiple temporal content profiles may be synchronized across different time zones, across different time slots, text phrases, story attributes, etc. Multiple temporal content profiles may even be synchronized based on similar content such as similar news stories.

FIG. 13 illustrates other embodiments of steps performed by the temporal content profile creating process 170 with different types of outputs of representations of the first temporal content profile 115 to the user interface 340A.

In step 226 of this embodiment, the temporal content profile creating process 170 outputs the representation of the first temporal content profile 115R to a user interface 340A. As depicted in FIG. 14, the temporal content profile creating process 170 renders a representation of the first temporal content profile 115R, a representation of the second temporal content profile 185R, and a representation of the third temporal content profile 380R on the user interface 340A. In this example, each of the representations are displays of a respective thumbnail video of temporal content associated with each respective temporal content profiles as well as other representations of metadata such as the graphs 320-1, 320-2 and 320-3.

In step 227, the temporal content profile creating process 170 outputs after receiving a search request. In an example embodiment, a user chooses to search the temporal content for a keyword or keyword phrase. Using the user interface 340A, the user enters the keyword or keyword phrase.

In step 228, the temporal content profile creating process 170 compares the metadata of the temporal content profile with the search request to define a search result. In an example embodiment, after receiving the search request (for example, a keyword or keyword phrase), the temporal content profile creating process 170 compares the metadata with the search request. For example, a user may search the temporal content for particular content. The temporal content profile creating process 170 receives a keyword or keyword phrase entered by the user. The temporal content profile creating process 170 then compares the keyword or keyword phrase with the metadata, such as closed captioned text data.

In step 229, the temporal content profile creating process 170 outputs the search result to the user interface 340A. In an example embodiment, a user enters a keyword or keyword phrase into the user interface 340A to search for temporal content containing that keyword or keyword phrase. The temporal content profile creating process 170 compares the keyword or keyword phrase to the metadata associated with the temporal content, and outputs the results to the user interface 340A. In other words, the user may search television programs for instances of a keyword or keyword phrase, and the temporal content profile creating process 170 outputs a representation of the temporal content profiles containing those keyword or keyword phrases on the user interface 340A.

Alternatively, in step 230, the temporal content profile creating process 170 is configured to receive a user defined metadata. In an example embodiment, a user can add metadata to a temporal content profile. For example, the user may use a segment editor on the user interface 340A to create segments within the temporal content. The user may search on metadata, such as closed captioned text, to locate sections of the video at which to create the segments. In another example embodiment, the user may use the segment editor to create, modify, view and/or analyze (for example, analyze audience demographics) segments. When creating segments, the user may add metadata to the segments to provide additional data for segment analysis. The user may also define metadata for the segments.

In step 231, the temporal content profile creating process 170 synchronizes the user defined metadata with the content instance. In an example embodiment, when a user adds metadata to a temporal content profile, such as when a user adds metadata to user created segments, the temporal content profile creating process 170 synchronizes that user defined metadata with the content instance so that it is available for outputting.

Alternatively, in step 232, the temporal content profile creating process 170 stores the representation of the temporal content profile. As depicted in FIG. 17, a user may run an analysis of one or more temporal content profiles. The temporal content profile creating process 170 outputs those representations of the temporal content profiles to the user interface 340A, makes it otherwise available to the user interface or stores the representations of the temporal content profile.

In step 233, the temporal content profile creating process 170 transmits the representation of the temporal content profile. In an example embodiment, a user runs an analysis of one or more temporal content profiles. The temporal content profile creating process 170 outputs the representations of the temporal content profiles to the user interface 340A. As depicted in FIG. 17, the user may choose to email (using the email button/icon 345) that analysis to another user. Upon direction from the user, the temporal content profile creating process 170 transmits the representations of the temporal content profiles to another user.

FIG. 14 illustrates an example user interface 340A where the temporal content profile creating process 170 renders a representation of the first temporal content profile 115R, a representation of the second temporal content profile 185R, and a representation of the third temporal content profile 380R on the user interface 340A. A graph region 310 displays metadata, in this example, ratings data. A gains and losses region 320 displays an audience measure associated with each respective temporal content profile. In other words, the gains and losses region 320-1 is associated with the representation of the first temporal content profile 115R, the gains and losses region 320-2 is associated with representation of the second temporal content profile 185R and the gains and losses region 320-3 is associated with representation of the third temporal content profile 380R. In this example embodiment, the bars above the zero value of the timeline represent audience gains (over time), and the bars below the zero value of the timeline represent audience losses (over time).

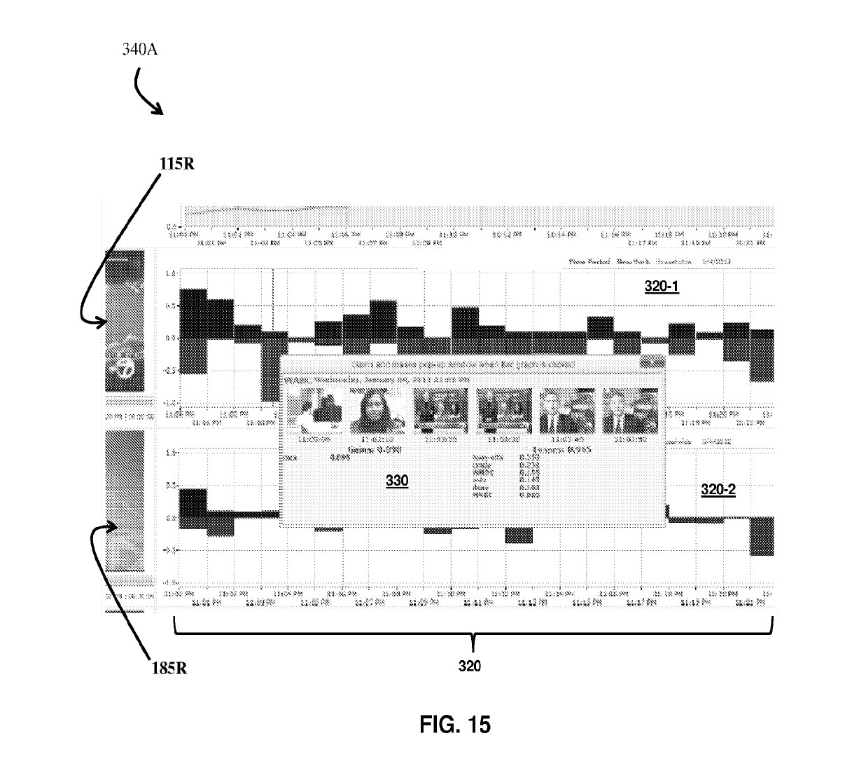

FIG. 15 illustrates an example user interface 340A depicting a representation of the first temporal content profile 115R, and a representation of the second temporal content profile 185R, along with an audience measure graph region 330. The representation of the first temporal content profile 115R includes a gains and losses region 320-1 associated with the representation of the first temporal content profile 115R. The representation of the second temporal content profile 185 includes a gains and losses region 320-2 associated with the representation of the second temporal content profile 185R. In an example embodiment, the gains and losses region 320 renders information related to where an audience measure increased, and where an audience measure decreased. In an example embodiment, this information is rendered in a pop up window as an audience measure graph region 330. In other words, the audience measure graph region 330 displays which television stations an audience measure was gained from, and which television stations an audience measure was lost to.

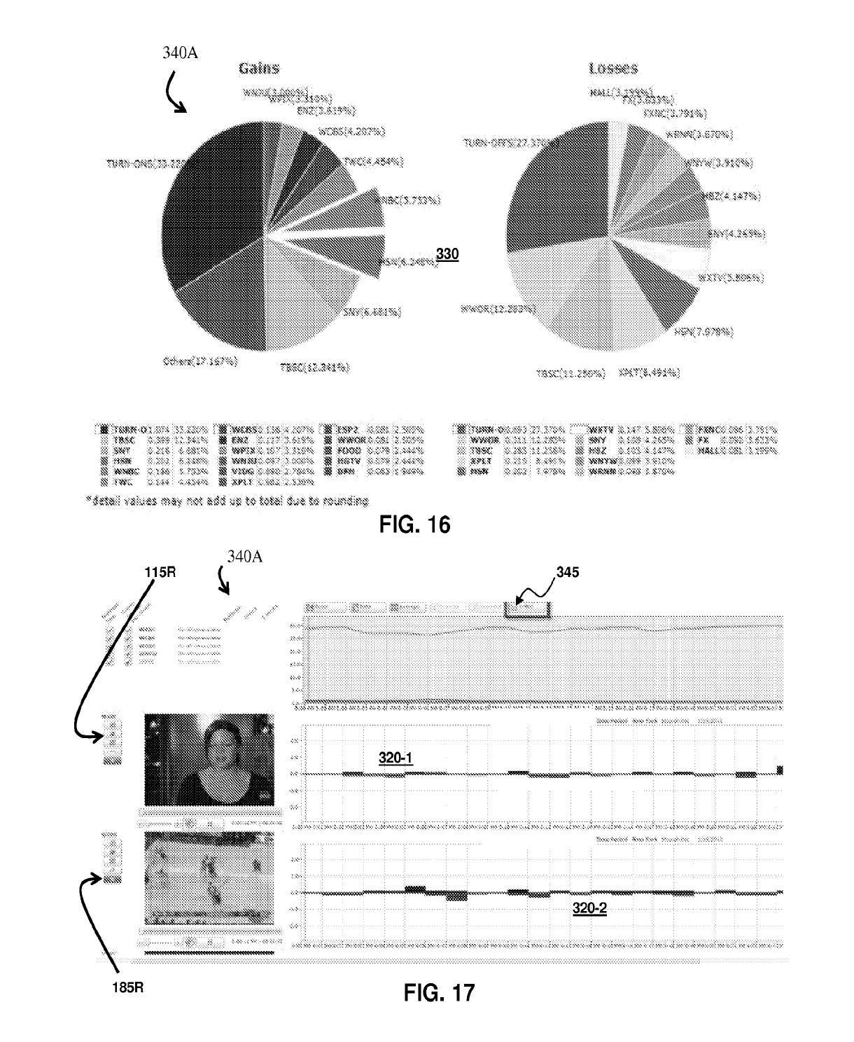

FIG. 16 illustrates an example user interface 340A depicting an audience measure graph region 330 depicted as pie charts. In an example embodiment, the temporal content profile creating process 170 renders an audience measure graph region 330 on the user interface 340A in the form of pie charts. Within the audience measure graph region 330, each pie chart displays which television stations an audience measure was lost to, and which television stations an audience measure was gained from. In another example embodiment, the temporal content profile creating process 170 only renders the top percentages of gains and losses within the pie charts so as to render each segment large enough to be visible on the user interface 340A.

FIG. 17 illustrates an example user interface 340A depicting a representation of the first temporal content profile 115R, and a representation of the second temporal content profile 185R, where each of the representations can be stored and transmitted. The representation of the first temporal content profile 115R includes a gains and losses region 320-1 associated with the representation of the first temporal content profile 115R, and the representation of the second temporal content profile 185R includes a gains and losses region 320-2 associated with the representation of the second temporal content profile 185R. In an example embodiment, the temporal content profile creating process stores the representation of the first temporal content profile 115R, and a representation of the second temporal content profile 185R. With this embodiment, a user may invoke transmittal of the representation of the first temporal content profile 115R, and representation of the second temporal content profile 185R, for example, to an email recipient by selecting the email button/icon 345. The temporal content profile creating process 170 then transmits the representation of the first temporal content profile 115R, and representation of the second temporal content profile 185R to the email recipient. In an example embodiment, the representations are transmitted as a hyperlink to a web page where the email recipient can interact with the representation of the first temporal content profile 115R, and the representation of the second temporal content profile 185R. In another example embodiment, the user who invoked transmission of the representations can view, within a representations vault, whether the email recipient has viewed the representations (via the hyperlink that was emailed to the email recipient). In some embodiments, the user may email a graphic representation of the temporal content profile to another user.

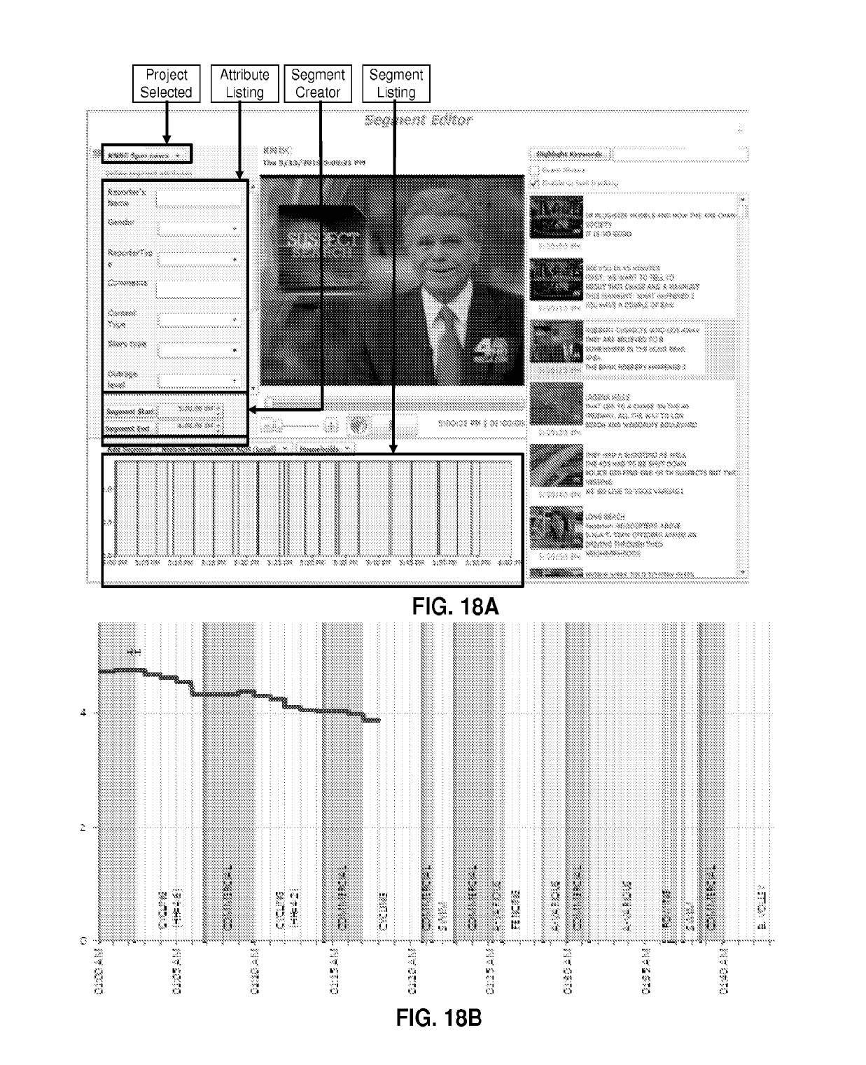

As shown in FIG. 18A, some embodiments allow a user to create metadata such as content attributes identifying segments and provide it to the temporal content profile creating process. In the embodiment of a user interface shown in FIG. 18A, to create a new segment, the user may select the appropriate project/program, set segment start and segment end times of the segment, complete and select the content attribute listings, and then press the “Add Segment” button in the segment creator. This creates a segment defined by the start and end times of the segment and any content attributes identified such as the segment value.

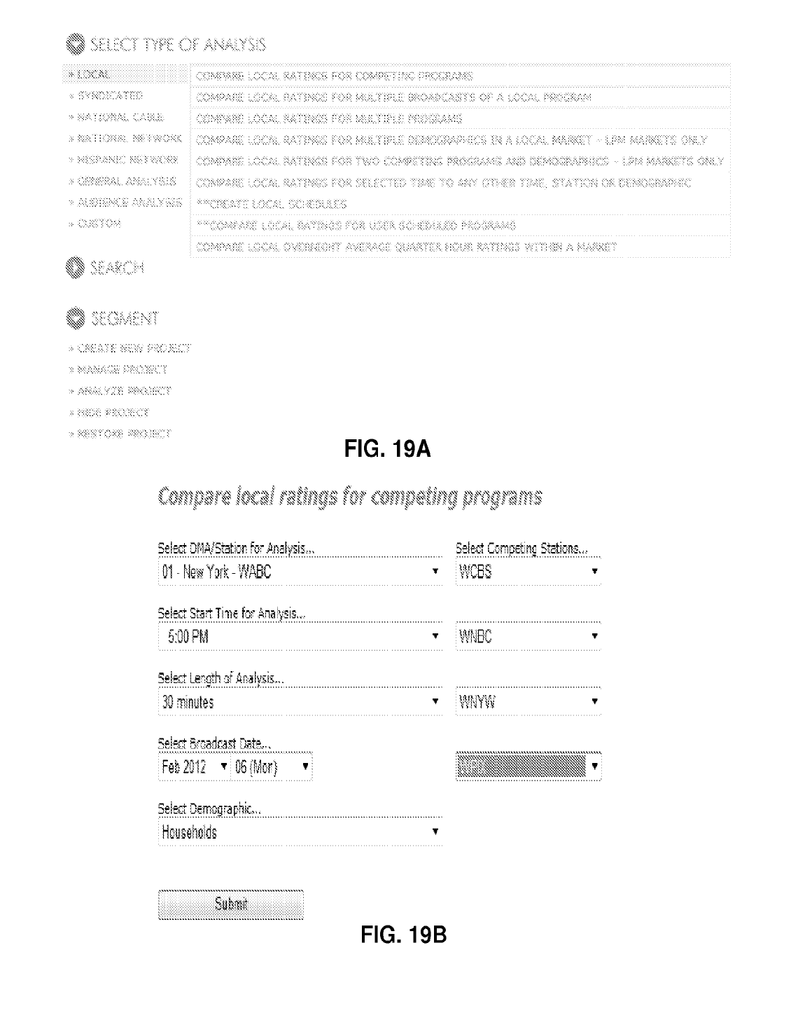

FIGS. 19A and 19B illustrate one example embodiment of a user interface for a temporal content profile system. FIG. 19A shows example types of comparisons that can be selected. FIG. 19B shows one example of a time-based analysis launched upon selection in the interface of FIG. 19A. This analysis is based on metadata such as DMA Station, start time, broadcast date, demographic and station. Upon selection of the metadata, the selection is submitted and a comparison of the temporal content profiles is determined.

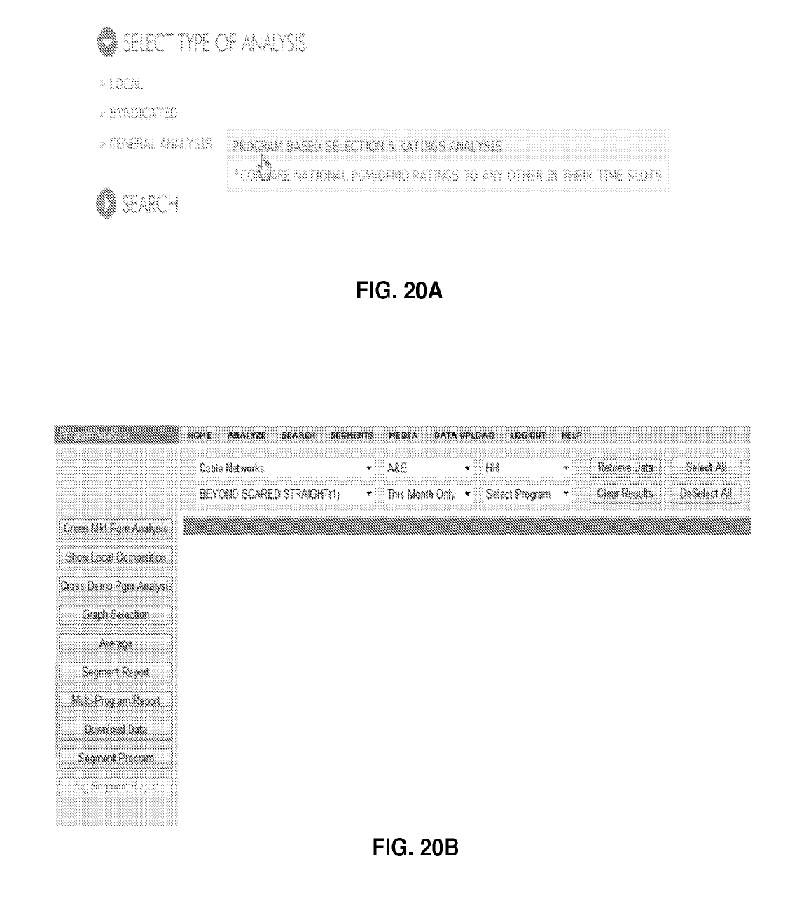

FIGS. 20A and 20B illustrate one example embodiment of a user interface for a temporal content profile system. FIG. 20 shows example types of comparisons that can be selected. FIG. 20B shows one example of a program-based analysis launched upon selection in the interface of FIG. 20A. This analysis is based on selected metadata fields and values such as network type, program name, demographic, month and may show different comparisons based on the compared metadata values of metadata fields such as local competition, average rating, segments, multi-programs and cross programs. Upon selection of the selected metadata field or value and the compared metadata field or value, the selection is submitted and a comparison of the temporal content profiles is determined.

In some embodiments of the systems and methods for creating a temporal content profile, users are also able to upload metadata to be associated with the temporal content through a user interface. In these embodiments, a user interface allows files from the user's client computer to be selected, uploaded and provided to the temporal content profile creating process. Once provided to this process, the user provided data can be treated as other metadata and may be used with a temporal content profile. For example, the systems and methods may allow users to view the metadata as part of a temporal content profile in a graph format, such as shown in FIG. 14. In some embodiments, the systems and methods may also allow users to download the data so that they may manipulate the data. In some embodiments, the systems and methods further comprise storing the representation of the temporal content profile on a remote client device such as the user's local computer. In some embodiments, the user can download an analysis of the data in a format such as an Excel file that may run macros and produce charts using the Excel executable program. FIG. 18B illustrates an example time-of-program graphical representation of a program with several segments identified on the graph as may have been identified and uploaded by the user and then downloaded by the user in an Excel file that uses macro's to display the analysis of the data. The analysis of the data may be shown as a graphic. FIG. 18B also shows a graphical representation of ratings data including a demographic (HH—Household).

In some embodiments, the temporal content profile creating processes and systems are capable of creating separate temporal content profiles based on metadata such as segment data. For example, similar segments from different content may synchronized on the segment field value so that other metadata values may be compared. As an illustration and not for limitation, different broadcast TV stations may be able to have the local weather section of the show defining a segment of that show. These types of local weather segments, from different station's news programs, could be used to create separate temporal content profiles that could then be synchronized and compared. An example of one possible type of comparison could be to compare average ratings of the segments across the different shows independent of the time-in-program or time-of-day.

In one embodiment, the temporal content profile creating process may comprise synchronizing a segment start, a segment end, a segment and a time-in-program value as metadata for a first temporal content profile and synchronizing the first temporal content profile with a second temporal content profile based on the time-in-program value whereby the segment start, the segment end and the segment value can define a new segment start, a new segment end and a new segment value for the second temporal content profile. One example of this type of automatically segmenting content may be to use one segment, based on a time-in-program value, of a program in Boston to define the similar segment of the same show in San Francisco so that ratings of similar shows, during similar segments, can be compared independent of time and market. This automatically segmenting can accommodate different time zones.

In some embodiments, temporal content profile creating processes and systems allow and assist the user in uploading metadata for use by the process. In one embodiment, these systems and process may comprise receiving content attributes comprising a raw upload metadata defining a first upload metadata field and first upload metadata value, accepting the raw upload metadata as a verified upload metadata if the first upload metadata field matches an allowable metadata field and if the first upload metadata field value matches an allowable first metadata field value and synchronizing the verified upload metadata with the first temporal content profile. For example, users may be able to upload user generated raw upload metadata, such as segment data, through a user interface module such as pull-down menus that enable the user to select the files to upload from their local computer. The users may be assisted in the upload process through an upload checker process that ensures the uploaded file conforms to the allowable file upload requirements of the temporal content profile creating process. The upload checker process checks metadata selected for uploading against the allowable metadata field and allowable metadata field value requirements to ensure that the raw upload metadata is in the proper format for use by the temporal content profile creating process. The upload checker process may include checks to ensure the file type is an Excel file and may ensure the metadata fields and the metadata field values conform to allowable upload requirements. If the metadata file does not comply with the allowable file upload requirements, the upload checker process will not accept the upload to be completed. If the file complies with the allowable file upload requirements, the upload checker will allow the upload. Once the file is uploaded and, it can be viewed in the custom analysis scenario interface to generate graphs based on the metadata or temporal content uploaded.

It is understood that in some embodiments, the user may be able to upload temporal content with or without any associated metadata.

In some embodiments, temporal content profile creating processes and systems utilize data summary techniques to display temporal content profiles. For example, some metadata may be provided in intervals of seconds which, when displayed on a common computer display, may not have enough pixels to show every second of a program. In these instances, the second-by-second data may be averaged over periods, intermittently used or otherwise summarized so that the metadata may be displayed on the display.

In some embodiments, the methods of creating a temporal content profile may further comprise selecting a program value of a program field from a temporal content profile, synchronizing a first demographic field value of a first demographic field and a second demographic field value of a second demographic field and comparing the first demographic field value and the second demographic field value. For example, these embodiments may synchronize temporal content profiles on the metadata field value of a specific program name and provide for comparisons of demographic for that program name. For example, this embodiment may comprise a cross-demographic analysis of a media content by selecting a television program and viewing and comparing ratings data representing different demographics as different graphic values on one graph.

In some embodiments, temporal content profile creating processes and systems may provide the ability for users to share data within the systems with other users. For example, the user interface may provide a way for the user to select data in the system and email it to another person or enable the user to download the data to their client device.

One example embodiment of the systems and methods for creating a temporal content profile may be embodied in a computer program product, the computer program product comprising a computer readable medium having a computer readable program code tangibly embodied therewith, the computer program code configured to implement the methods described herein, and which, when loaded in a computer system comprising a processor, is able to carry out these methods.

Although embodiments disclosed herein have been described in the above forms with a certain degree of particularity, it is understood that the foregoing is considered as illustrative only of the principles of embodiments disclosed herein. Further, since numerous modifications and changes will readily occur to those skilled in the art, it is not desired to limit embodiments disclosed herein to the exact construction and operation shown and described, and accordingly, all suitable modifications and equivalents may be resorted to, falling within the scope of embodiments disclosed herein that are defined in the claims and their equivalents.

1. A computer implemented method of creating a temporal content profile, the computer comprising a processor and a memory, the method comprising:
receiving a first temporal content having a first content instance and a second content instance;
receiving a first metadata associated with the first content instance and a second metadata associated with the second content instance where the first metadata comprises a first ratings data and the second metadata comprises a second ratings data;
creating a first content instance profile by synchronizing the first content instance with the first metadata;
creating a second content instance profile by synchronizing the second content instance with the second metadata; and
creating a first temporal content profile from the first content instance profile and the second content instance profile.

2. The computer implemented method of claim 1 wherein the first metadata further comprises a first content attribute and the second metadata further comprises a second content attribute.

3. The computer implemented method of claim 2 further comprising automatically determining the second content attribute from the second content instance.

4. The computer implemented method of claim 1 wherein:
the first metadata further comprises a first text data; and
the second metadata further comprises a second text data.

5. The computer implemented method of claim 4 wherein:
the first temporal content is a media program; and
the first text data and the second text data comprises closed caption text data.

6. The computer implemented method of claim 5 wherein:
the first temporal content further comprises a plurality of content instances over a duration of the media program;
the text data comprises a plurality of closed caption text data over the duration of the media program; and
the ratings data comprises a plurality of ratings data over the duration of the media program.

7. The computer implemented method of claim 1 wherein a user generates one of the first metadata or the second metadata.

8. The computer implemented method of claim 1 wherein the first metadata comprises a first demographic data and the second metadata comprises a second demographic data.

9. The computer implemented method of claim 1 wherein:
the first ratings data comprises a first audience measure associated with the first content instance, a second audience measure associated with the second content instance;
the step of creating the second content instance profile further comprises automatically determining an audience change measure between the first audience measure and the second audience measure at the second content instance; and
the step of creating the second content instance profile further comprises automatically determining an add audience measure reflecting an increase in the audience change measure and determining a loss audience measure reflecting a decrease in the audience change measure.

10. The computer implemented method of claim 9 further comprising:
receiving a second temporal content; and
the step of creating the second content instance profile further comprises determining a transfer audience measure reflecting a transfer of an audience between the first temporal content and the second temporal content.

11. The computer implemented method of claim 1 further comprising:
storing an alarm trigger;
comparing the alarm trigger to the temporal content profile; and
communicating an alarm when the alarm trigger is in the temporal content profile.

12. A computer implemented method to compare temporal content, the computer comprising a processor and a memory, the method comprising:
receiving a first temporal content and a second temporal content;
the first temporal content associated with a first metadata and the second temporal content associated with a second metadata;
the first metadata and the second metadata comprising at least one metadata field having at least one metadata field value;
selecting at least one metadata field as a selected metadata field;
synchronizing the first metadata and the second metadata on a selected metadata field value of the selected metadata field;
selecting at least one metadata field as a compared metadata field; and
comparing the metadata field value of the compared metadata field of the first metadata to the metadata field value of the compared metadata field of the second metadata to compare the first temporal content to the second temporal content.

13. The computer implemented method of claim 12 wherein:
the selected metadata field comprises a time-of-day field; and
the compared metadata field comprises a ratings field.

14. The computer implemented method of claim 12 wherein:
the selected metadata field comprises a time-of-day field, a channel field and a demographic field; and
the compared metadata field comprises a ratings field.

15. The computer implemented method of claim 12 wherein:
the selected metadata field comprises a program field; and
the compared metadata field comprises a ratings field.

16. The computer implemented method of claim 12 wherein:
the selected metadata field comprises a program field, a time-in-program field and a demographic field; and
the compared metadata field comprises a ratings field.

17. The computer implemented method of claim 12 wherein:
the first temporal content comprises a first media program;
the second temporal content comprises a second media program;
the selected metadata field value comprises a program field, a time-of-day field and a time-in-program field;
the compared metadata field value comprises an audience measure of each of the first and second media program; and
the comparison of the first temporal content to the second temporal content is a graphical representation of the audience measure of each of the first and second media program.

18. The computer implemented method of claim 12 further comprising receiving a third temporal content associated with a third metadata;
the third metadata comprising one or more metadata fields having one or more metadata field values;
synchronizing the third metadata on the selected metadata field value of the selected metadata field; and
comparing the metadata field value of the compared metadata field of the first metadata to the metadata field value of the compared metadata field of the third metadata field to compare the first temporal content to the third temporal content.

19. (canceled)

20. A computer implemented method of outputting a representation of a first temporal content profile, the method comprising:
receiving a representation of a first temporal content profile comprising a first content instance profile;
the first content instance profile comprising a content instance synchronized with a metadata;
the metadata comprises a ratings data, a content attribute and a text data; and
outputting the representation of the first temporal content profile to a user interface.

21. The computer implemented method of claim 20 further comprising outputting a representation of a second temporal content profile to the user interface.

22. (canceled)

23. (canceled)

24. (canceled)

25. (canceled)

26. (canceled)

27. (canceled)

28. (canceled)

29. (canceled)

30. (canceled)

31. (canceled)
